(19) United States
(12) Patent Application Publication
(10) Pub. No.: US 2012/0304130 A1
(43) Pub. Date: Nov. 29, 2012

(54) SYSTEMS, METHODS, AND COMPUTER-READABLE MEDIA FOR MONITORING COMMUNICATIONS ON A NETWORK

(75) Inventors: Gordon H. Rueff, Idaho Falls, ID (US); Jared A. Verba, Idaho Falls, ID (US); Kenneth W. Rohde, Idaho Falls, ID (US); Corey W. Thuen, Idaho Falls, ID (US); James R. Davidson, Sequim, WA (US)

(73) Assignee: BATTELLE ENERGY ALLIANCE, LLC, Idaho Falls, ID (US)

(21) Appl. No.: 13/478,343

(22) Filed: May 23, 2012

Related U.S. Application Data
(60) Provisional application No. 61/489,966, filed on May 25, 2011.

(51) Int. Cl. G06F 15/173; G06F 3/048

(52) U.S. Cl. 715/850; 709/224

(57) ABSTRACT

Network monitoring systems, computer-readable storage media, and methods monitor a network. Communication data is captured from the network in a substantially passive manner. The communication data is organized to represent a plurality of conversations between a plurality of hosts on the network. Each conversation of the plurality includes a first address of a first host of the plurality of hosts, a service port identifier on the first host, and a second address of a second host of the plurality of hosts. Information correlated to at least some of the plurality of conversations is presented on a graphical user interface.

### CROSS-REFERENCE TO RELATED APPLICATION

This application claims priority to U.S. Provisional Patent Application Ser. No. 61/489,966, filed May 25, 2011, the disclosure of which is hereby incorporated herein in its entirety by this reference.

### GOVERNMENT RIGHTS

This invention was made with government support under Contract Number DE-AC07-051D14517 awarded by the United States Department of Energy. The government has certain rights in the invention.

### TECHNICAL FIELD

Embodiments of the present disclosure relate generally to network security and, more specifically, to systems and methods for monitoring communications on a network.

### BACKGROUND

Corporate networks are dynamic in nature where hosts, services, applications, and users are constantly changing. In contrast, Industrial Control Systems (ICSs) use a largely static set of communication pathways, applications, and users. Corporate networks typically utilize traditional Information Technology (IT) priorities that follow the Confidentiality, Integrity, and Availability (CIA) Model. ICSs typically reverse these priorities and use an Availability, Integrity, and Confidentiality (AIC) Model. Conventional IT systems undergo periodic hardware and software updates in the range of 3 to 5 years. An ICS may have a lifespan of 15 to 20 years or more.

The dichotomy between the two environments may limit the effectiveness of conventional IT tools in evaluating the cyber security profile of an ICS. The development of conventional IT tools that address a dynamic environment likely increases tool complexity. In addition, these tools may require specialized knowledge to use the tool effectively, which may adversely impact the availability of the ICS. Conversely, the ICS environment may allow for software designs that are less complex and may be easier to learn and use effectively.

There is a need for tools to passively identify components and communications on a network environment so a user can more easily manage the network, discover changes in the network, or a combination thereof.

### BRIEF SUMMARY

Embodiments of the present disclosure provide tools to identify components and communications on a network environment in a substantially passive manner so a user can more easily manage the network, discover changes in the network, or a combination thereof.

Embodiments of the present disclosure include a method for monitoring a network, including capturing communication data from the network in a substantially passive manner. The communication data is organized to represent a plurality of conversations between a plurality of hosts on the network. Each conversation of the plurality includes a first address of a first host of the plurality of hosts, a service port identifier on the first host, and a second address of a second host of the plurality of hosts. Information correlated to at least some of the plurality of conversations is presented on a graphical user interface.

Embodiments of the present disclosure include a network monitoring system including at least one collector, at least one aggregator, and a graphical user interface. The at least one collector is configured for coupling with a network and configured to capture communication data from the network in a substantially passive manner. The at least one aggregator is configured to receive the communication data from the at least one collector and organize the communication data to represent a plurality of conversations between a plurality of hosts on the network. Each conversation of the plurality includes a first address of a first host of the plurality of hosts, a service port identifier on the first host, and a second address of a second host of the plurality of hosts. The graphical user interface is configured to present information correlated to at least some of the plurality of conversations.

Embodiments of the present disclosure include computer-readable storage media including computing instructions, which when executed by a computing device cause the computing device to capture communication data from the network in a substantially passive manner. The computing instructions also cause the computing device to organize the communication data to represent a plurality of conversations between a plurality of hosts on the network. Each conversation of the plurality includes a first address of a first host of the plurality of hosts, a service port identifier on the first host, and a second address of a second host of the plurality of hosts. The computing instructions also cause the computing device to present information correlated to at least some of the plurality of conversations on a graphical user interface.

### BRIEF DESCRIPTION OF THE DRAWINGS

FIG. 1 is a block diagram of a network that includes a network monitoring system according to an embodiment of the present disclosure;

FIG. 2 is a high-level schematic block diagram of a network monitoring system according to an embodiment of the present disclosure illustrated from a more functional perspective relative to FIG. 1;

FIG. 3 is a high-level schematic block diagram of a network monitoring system according to another embodiment of the present disclosure;

FIG. 4 depicts relationships of certain records as a permutable tree structure;

FIG. 5 is a diagram illustrating a conversation composition according to an embodiment of the present disclosure;

FIG. 6 shows a status page of Sophia according to an embodiment of the present disclosure;

FIG. 7 is a table view for a host table;

FIG. 8 is a table view for a channel table;

FIGS. 9-11 are graphical user interfaces (GUIs) depicting various channel tree views that allow users to explore such users' systems by organizing the channels into different trees;

FIG. 12 is a GUI configured to display new host alerts generated by Sophia after creating a baseline fingerprint;

FIG. 13 is a GUI that shows an example of an alert generated from a black-listed channel;

FIG. 14 is a flow diagram illustrating a process for merging device-specific records from substantially real-time capture into a fingerprint;

FIG. 15 is a flow diagram illustrating a process for merging information from historical files into a master database;

FIG. 16 is a flow diagram illustrating a process for identifying a valid channel;

FIG. 17 is a flow diagram illustrating a process for generating alerts for new and abnormal conversations and devices;

FIG. 18 is a flow diagram illustrating a process for estimating a client-server relationship from a single packet of a session;

FIG. 19 illustrates a GUI including a three-dimensional environment with graphical elements correlated with selections in a permutable tree structure;

FIG. 20 illustrates a GUI including a three-dimensional environment with a baseline layout of icons representing sub-networks and hosts and illustrating packets as animated lines connected between hosts;

FIG. 21 illustrates a GUI including a three-dimensional environment with graphical elements correlated with hosts, and channels between some of the hosts;

FIG. 22 illustrates a GUI including a three-dimensional environment with graphical elements correlated with selections in a permutable tree structure and including sub-networks, hosts, and channels;

FIG. 23 illustrates a GUI including a three-dimensional environment with graphical elements illustrating a bubble-up process;

FIGS. 24A-24C illustrate a GUI including a three-dimensional environment illustrating sub-networks, hosts, and channels and including a geographic representation of channels associated with specific geographic locations from different perspectives; and

FIG. 25 illustrates a GUI including an example of a heads-up display.

### DETAILED DESCRIPTION

In the following detailed description, reference is made to the accompanying drawings which form a part hereof and in which are shown by way of illustration, specific embodiments in which the invention may be practiced. These embodiments are described in sufficient detail to enable those of ordinary skill in the art to practice the invention, and it is to be understood that other embodiments may be utilized, and that structural, logical, and electrical changes may be made within the scope of the disclosure.

In this description, specific implementations are shown and described only as examples and should not be construed as the only way to implement the present invention unless specified otherwise herein. It will be readily apparent to one of ordinary skill in the art that the various embodiments of the present disclosure may be practiced by other partitioning solutions. For the most part, details concerning timing considerations and the like have been omitted where such details are not necessary to obtain a complete understanding of the present disclosure and are within the abilities of persons of ordinary skill in the relevant art.

Referring in general to the following description and accompanying drawings, various embodiments of the present disclosure are illustrated to show its structure and method of operation. Common elements of the illustrated embodiments may be designated with similar reference numerals. It should be understood that the figures presented are not meant to be illustrative of actual views of any particular portion of the actual structure or method, but are merely idealized representations employed to more clearly and fully depict the present invention defined by the claims below.

It should be appreciated and understood that information and signals may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and that embodiments of the present disclosure may be implemented on any number of data signals including a single data signal.

It should be further appreciated and understood that the various illustrative logical blocks, modules, circuits, and algorithm acts described in connection with embodiments disclosed herein may be implemented as electronic hardware, computer software, or combinations of both. To clearly illustrate this interchangeability of hardware and software, various illustrative components, blocks, modules, circuits, and steps are described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the embodiments of the disclosure described herein.

The various illustrative logical blocks, modules, processes, and circuits described in connection with the embodiments disclosed herein may be implemented or performed with a general-purpose processor, a special-purpose processor, a Digital Signal Processor (DSP), an Application Specific Integrated Circuit (ASIC), a Field-Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. When executed as firmware or software, the instructions for performing processes described herein may be embodied in computer-readable media such as, for example, computer-readable storage media.

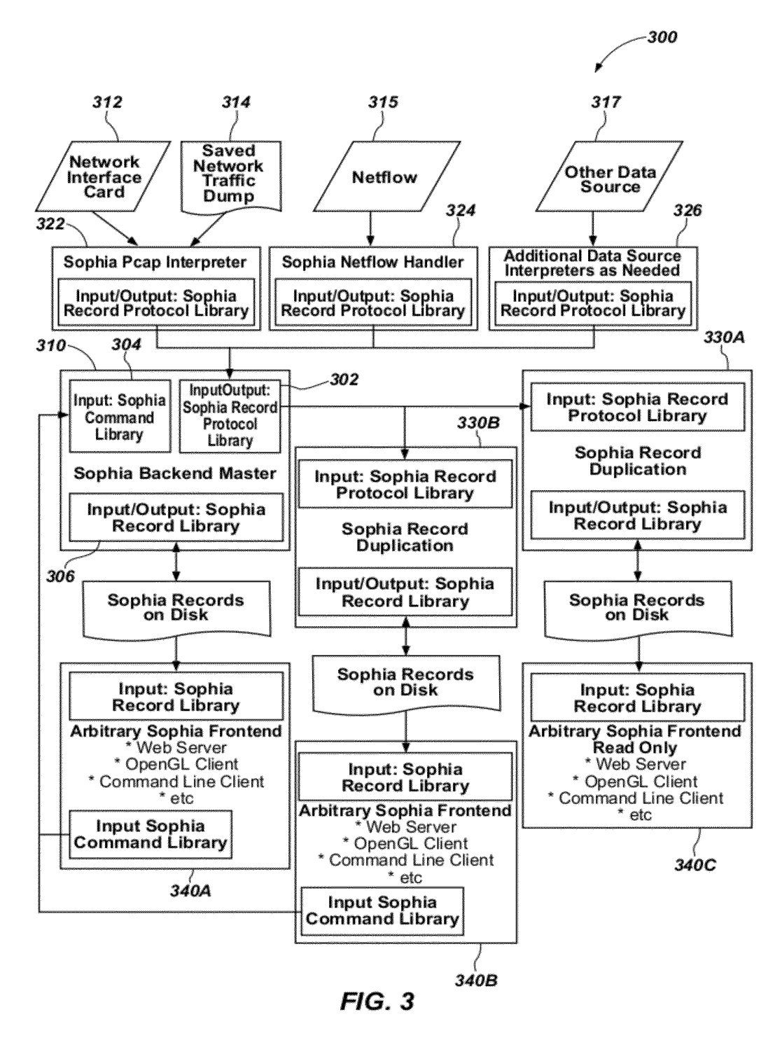

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part, element number indicators begin with the number of the drawing on which the elements are introduced or most fully discussed. For example, where feasible, elements in FIG. 3 are designated with a format of 3xx, where 3 indicates FIG. 3 and xx designates the unique element.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. Also, unless stated otherwise, a set of elements may comprise one or more elements.

The inventors have identified a number of issues regarding cyber security evaluations of ICSs and Supervisory Control and Data Acquisition (SCADA) systems and their deployments in the field. First, knowledge of all the details of an installation of an ICS is often incomplete. For example, network topologies are often not fully documented, required ports and services are often unknown, and the resources required to obtain this information are not always available. Vendors can help with the ports and services for relatively new systems; however, older legacy systems are often unsupported by the vendor, or in some cases the vendor no longer exists. As a result, it becomes the responsibility of personnel managing the network to perform this evaluation. Second, personnel responsible for most ICS installations are dedicated to maintaining the availability of the system. Configuration management is often overlooked, as the emphasis on “keeping the system running” takes most of the personnel time. Third, traditional tools for evaluating network topology, identifying ports and services, and cyber security evaluations can be dangerous when used on an ICS. Fourth, networking skills are not taught or emphasized, unlike a corporate network environment. In addition, network priorities (the CIA model) are reversed in ICS networks in comparison to typical corporate networks. Fifth, without concrete knowledge of the system configuration, the user may not be able to optimize the cyber security profile of an ICS.

The inventors have identified a need for tools that perforin one or more of the following tasks: learning about a system, particularly a system including an ICS network, using online passive monitoring techniques; establishing what components are in a system; identifying how the components communicate; capturing communication information on the network; generating a configuration baseline of the component communications; identifying deviations from the baseline in near-real-time; providing information to the network to build quality firewall rules; and performing the forgoing functions in a manner that is relatively easy to learn and use.

Embodiments of the present disclosure provide tools to identify components and communications on a network environment in a substantially passive manner so a user can more easily manage the network, discover changes in the network, or a combination thereof.

As used herein, the term “host record” means information identifying an element on a network, defined by a unique Internet Protocol (IP) address.

As used herein, the term “service record” means information identifying a combination of a host record and a service port associated with the host record.

As used herein, the term “channel record” means information identifying a combination of a service record and another host record acting as a client for the service record.

As used herein, the term “session record” means information identifying a channel record associated with a client port.

As used herein, the term, “conversation” means information identifying a combination of a service record, a channel record and a session record. A “conversation” may also be considered as a communication pathway between devices on a network.

As used herein, the term “fingerprint” means a catalog of conversations associated with a network (e.g., associated with an ICS).

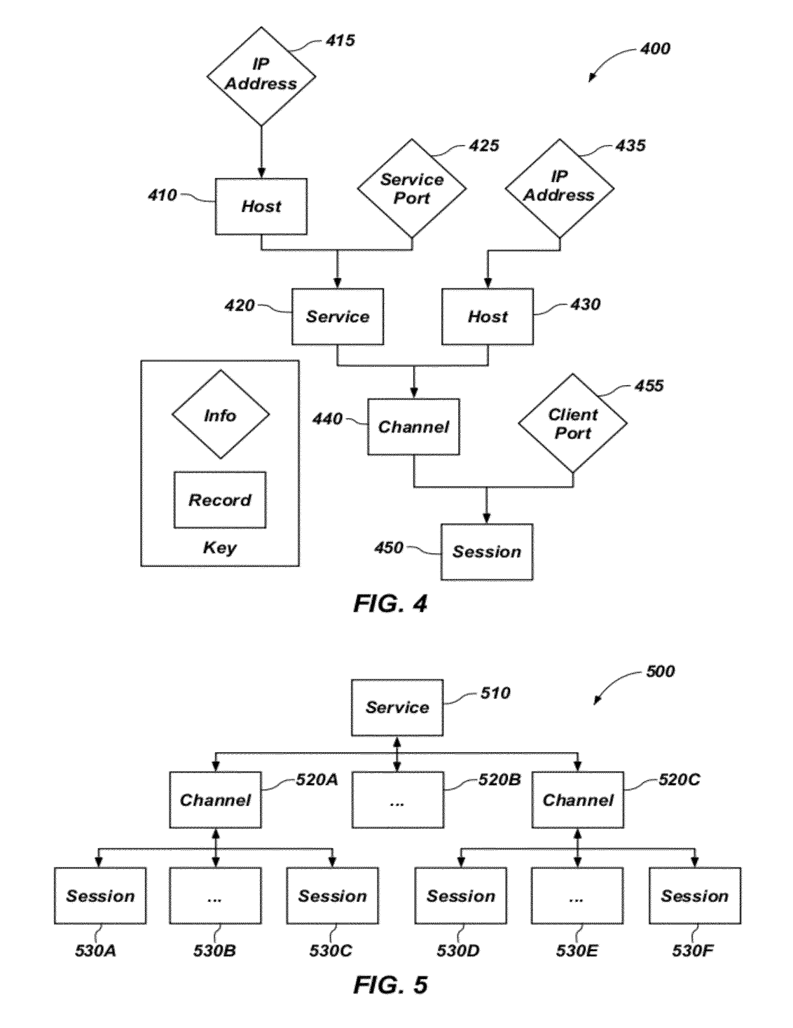

Details of the host record, service record, channel record, session record, and conversation may be found below in the discussion of FIG. 4. In addition, in some instances, where the context is appropriate, the various records or their underlying devices may be referred to without the “record” term. In other words, a “session” may be discussed and it will be understood that the “session” relates to a first host, a service port associated with the first host, a second host acting as a client of the first host, and a client port associated with the second host.

This disclosure may reference the term “Sophia,” which has been employed by the inventors as an internal project title for at least some of the subject matter of this disclosure. The term “Sophia” may also generally refer to a network monitoring system (e.g., tool) and related terms, as shown in the drawings and described herein. Therefore, the term “Sophia” should not be interpreted to have any meaning or functionality not related to what is described herein through the various examples.

The security of a network may be defined by its weakest link. To find the weakest link of the network, all links may be identified. One of the weakest links found in a majority of network assessments includes the presence of undocumented or undiscovered conversations without proper authentication techniques. Because a variety of ICS vendors exist, many of which create their own set of unique protocols for ICS communications, attempts to identify all ICS protocols may be complex and difficult. Embodiments of the present disclosure may include identifying a conversation on the network, and prompt a user to identify the conversation as “good” (i.e., acceptable, appropriate) or “bad” (i.e., unacceptable, inappropriate). Identifying a conversation on the network may include receiving communication data from a network, and generating a baseline fingerprint of the communication data on the network based on a subset of parameters of the communication data. Doing so may be useful in providing a deeper understanding of the ICS by the user for security and monitoring of the network. For example, an alert may be generated if a new communication falls outside of the baseline fingerprint. In addition, these practices may further assist in encouraging documentation of the system.

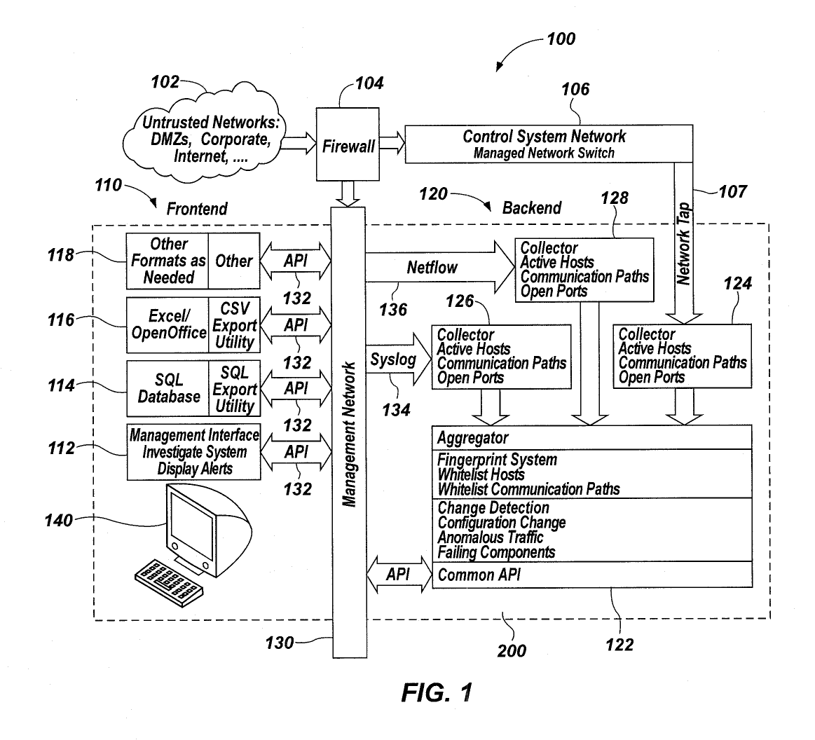

FIG. 1 is a block diagram of a network 100 that includes a network monitoring system 200 according to an embodiment of the present disclosure. In general, the network 100 may include a plurality of components that are configured to communicate with each other in order to accomplish tasks, such as baselining and monitoring complex and highly segmented networks that are often found in control system applications. These individual components may be configured to allow for a high degree of scalability for large networks and also allow for expandability in how monitoring data is viewed by operators. The components may be implemented as electronic hardware, computer software, or combinations of both, and may perform functions such as data collection, data evaluation, and data visualization.

The network monitoring system 200 includes a frontend 110 that is coupled to a backend 120 through a management network 130. The frontend 110 may be configured as a client for the network 100. For example, the frontend 110 may include applications and programs, such as a management interface 112, a database 114 (e.g., structured query language (SQL)), EXCEL®/OPENOFFICE® 116, and other applications and programs 118 that interact (e.g., communicate) with the management network 130 through an application programming interface (API) 132. For example, the management interface 112 may be configured to investigate the system, display alerts, etc.

Information related to the network monitoring system 200 may be presented to a user on a computing system 140 with one or more user interface elements. As non-limiting examples, the computing system 140 may be a user-type computer, a file server, a compute server, a notebook computer, a tablet, a handheld device, a mobile device, or other similar computer system for executing software. As non-limiting examples, the user interface elements may include elements such as displays, keyboards, mice, joysticks, haptic devices, microphones, speakers, cameras, and touchscreens. A display on the computing system 140 may be configured to present a graphical user interface with information about the network 100 gathered by the network monitoring system 200, as is explained below.

The backend 120 may include an aggregator 122, and one or more collectors 124, 126, 128 that communicate with the management network 130 or network taps 107 to a control system network 106. The backend 120 may be configured as a monitoring tool targeting scalability and expandability. The aggregator 122 (e.g., a central server) may communicate with the collectors 124, 126, 128 to gather data and form a substantial picture of relatively large, segmented networks found in most control system installations. A client/server architecture for the network 100 may allow multiple collectors 124, 126, 128 to be installed on all network segments that may be desired to be passively monitored or categorized regardless of the network size or segmentation. By adding additional collectors (not shown), more networks may be monitored and correlated. This architecture for the network 100 may further allow for redundant collectors to be installed on a single network segment to facilitate around-the-clock data collection regardless of maintenance cycles.

Each collector 124, 126, 128 may be configured to capture data from a specific source of network traffic (e.g., live or archived data), and may activate hosts, establish communication paths, open ports, etc. For example, a first collector 124 may capture data from the control system network 106, which may receive data from untrusted networks 102 (e.g., demilitarized zones (DMZs), corporate networks, the Internet, etc.) through a firewall 104. A second collector 126 may capture Syslog data 134. A third collector 128 may capture Netflow data 136 from routers (not shown). Collectors 124, 126, 128 may be configured to capture data from other sources.

The aggregator 122 may be a central server of the network monitoring system 200, and may be configured to process data from each of the collectors 124, 126, 128. The aggregator 122 may be responsible for creating a coherent view of the network 100 by storing activities into more easily usable data constructs. In addition to generating and organizing such data, the aggregator 122 may include (e.g., house) a compressed packet capture repository that is formed from each collector's individual packet repository. As a result, the aggregator 122 may synchronize data from each collector 124, 126, 128, as well as merge, overlap, or resolve any conflicts between network segments. The aggregator 122 may be configured to provide data from its synchronized coherent network view to each connected client.

The aggregator 122 may be configured to define and retain fingerprinting and change detection responsibilities as these tasks require the whole system viewpoint. Other tasks may be pushed out to the collectors 124, 126, 128, so that aggregator 122 responsibilities will remain relatively small, which may allow the aggregator 122 and the network monitoring system 200 to scale better between different network sizes.

While each of the collectors 124, 126, 128 is shown to capture data from a single source, one or more of the collectors 124, 126, 128 may be configured to capture information from more than one source at a time, which may provide a robust method of capturing information about a process control network, regardless of the complexity. In addition, each collector 124, 126, 128 may also be able to run on other servers. In other words, a central aggregator 122 may be configured as a collector, and other servers in the environment can collect data for the network 100, which may further assist in generating a baseline fingerprint.

The network monitoring system 200 may implement a unique baseline view of the network 100 and the activity on monitored network segments. An initial baseline fingerprint may be generated at the beginning of a network session, when the session direction and the client/server relationships are established. In a control system environment (e.g., ICS), the establishment of a session may occur at boot time, and last for weeks or more. In some embodiments, when starting a network capture, the initial handshakes of the current session may be missed. Without witnessing the initial handshakes, the network monitoring system 200 may not know which computer is the server and which computer is the client. As a result, the data in that session may not be applied to the baseline of the network 100. In the absence of guaranteed direction information, the network monitoring system 200 may be configured to implement a set of rules to estimate (i.e., “guess”) at the server and client relationship. The set of rules may be applied in an order that produces the most likely server and client relationship. For example, the network monitoring system 200 may assign the service to the host with the lower port number, and assign service to the destination host as is explained more fully below.

By implementing an expandable client/server architecture, several control system operators may view their network baseline and activity at the same time. This may be accomplished by implementing data visualization clients that interpret the collected data into information an operator can use. This information may include, for example without limitation, new network objects that have been detected and new ways existing network components have sent messages.

The network monitoring system 200 may be designed to be operated on its own network segment, separate from other control system installations, and to be able to use high-speed communications between each component. This does not mean, however, that the overall architecture may not need to implement authentication and encryption of data between components. By integrating existing encryption and authentication protocols (e.g., OPENSSL®, KERBEROS™, etc.) to leverage industry standard security implementations, data can be adequately protected between components. Proper encryption and authentication also allows for use of a data client outside of a network segment without worrying about data integrity or confidentiality. Therefore, software development may be performed by engineers and scientists experienced in secure coding practices, such as following secure coding guidelines established by the CERT/CC, Microsoft, and others. The software development lifecycle for the network monitoring system 200 may include periodic code reviews followed by security assessment activities that include, for example, without limitation, source code audits, network architecture reviews, network traffic analysis, penetration testing, and physical access analysis.

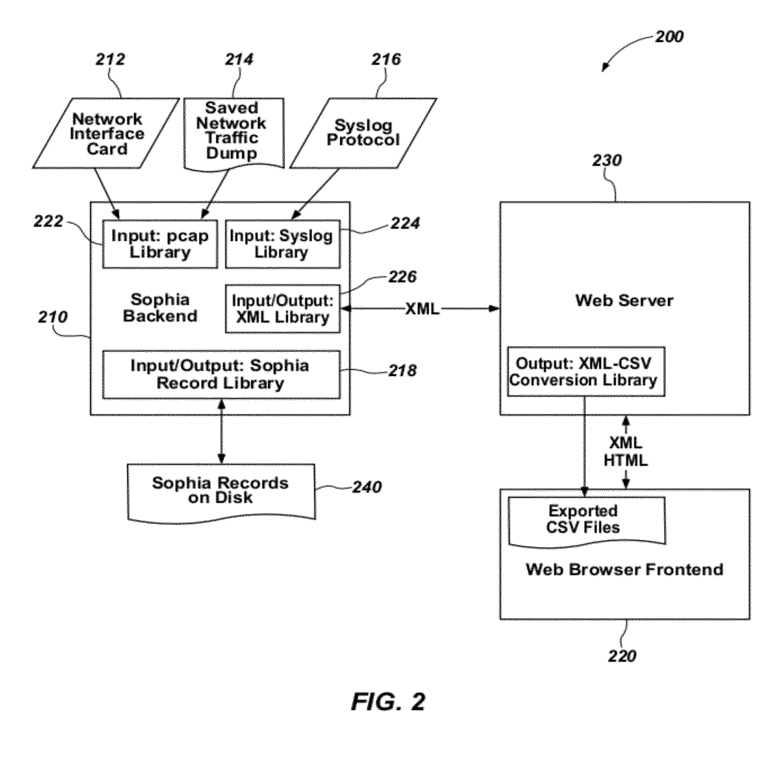

FIG. 2 is a high-level schematic block diagram of network monitoring system 200 according to an embodiment of the present disclosure illustrated from a more functional perspective. The network monitoring system 200 includes a Sophia backend 210, coupled with a Web browser frontend 220 through a Web server 230. The Sophia backend 210, Web browser frontend 220, and Web server 230 may communicate through languages, such as Extensible Markup Language (XML), Hypertext Markup Language (HTML), etc. The Sophia backend 210 further receives inputs from other components, such as a network interface card 212, saved network traffic 214, a file including Syslog protocol 216 information, and other sources. The Sophia backend 210 may maintain a record library 218, and may further save and retrieve records from the record library 218 from external sources 240.

As shown in FIG. 2, each input and output capability may be added into the same code base as the main Sophia process of the Sophia backend 210. In other words, all input and output of record information may be handled by the Sophia backend 210, which may result in additional code paths for every input and output method. For example, there may be software code (e.g., input box 222) that includes functionality to handle libpcap processing, other software code (e.g., input box 224) that includes functionality to handle Syslog processing, and additional software code (e.g., input/output box 226) that includes functionality to handle XML processing.

FIG. 3 is a high-level schematic block diagram of a network monitoring system 300 according to another embodiment of the present disclosure. A Sophia backend 310 may operate in combination with a Sophia frontend 340A. The network monitoring system 300 includes the development of a plurality of separate libraries. A first library may be a record protocol library 302. A second library may be a command library 304. A third library may be a record library 306. The record protocol library 302 may be an IP-based library for transferring Sophia records between processes (e.g., from a pcap interpreter 322, a netflow handler 324, and other data source interpreters 326). The command library 304 may be used for controlling the behavior of the network monitoring system 300, for example, by black listing certain channels, white listing certain channels, managing fingerprint mode, etc. The record library 306 may be used for manipulating on-disk records that the network monitoring system 300 uses for state saving and restoring.

Referring to FIGS. 2 and 3, the Sophia backend 210, 310 represents the Sophia core process functionality. In FIG. 2, the input code is represented by the input boxes 222, 224. In FIG. 3, the input code is represented by the pcap interpreter 322, netflow handler 324, and other data source interpreters 326. The output code of FIG. 2 is represented by the Web server 230 and Web browser frontend 220. The input/output box 226 may include both input and output code for XML communication with the Web server 230.

As non-limiting examples, the pcap interpreter 322 may receive data from a network interface card 312 and saved network dumps 314, the netflow handler 324 may receive netflow data 315, and the other data source interpreters 326 may receive data from other data sources 317.

Record duplication libraries 330A and 330B may be created to operate with additional Sophia frontends 340B and 340C to create substantially independent Sophia frontends 340B and 340C operating on separate data in each of the Sophia backend 310, and the record duplication libraries 330A and 330B, respectively. Information between the Sophia backend 310, and the record duplication libraries 330A and 330B may be synchronized periodically, or on an as-desired basis.

It may be desirable for the Sophia backend 210, 310 and record duplication libraries 330 to be relatively static so that updates are not needed frequently. The input and output code may be constantly growing to support new input and output formats. In FIG. 2, because at least a portion of the input and output code modules are inside code of the Sophia backend 210, the Sophia backend 210 may not be static, as the input and output code modules may need to be updated.

In contrast, as shown in FIG. 3, the input and output code modules may be located outside of the Sophia backend 310. As a result, if the additional input and output functionality is to be later added to Sophia, doing so may be accomplished without alteration to the core Sophia process code. For example, it may be desired for a syslog input program (not shown in FIG. 3) to be added with the network monitoring system 300 of FIG. 3 to convert syslog data into Sophia records that would be transmitted using the record protocol library 302. This additional feature may be added without changing the process code of the Sophia backend 310. Similarly, a new output format could be supported by simply writing a new program that can interpret Sophia's records on disk, without editing code of the Sophia backend 310.

In addition, while the network monitoring system 300 of FIG. 3 may appear more complicated than FIG. 2, additional simplification goals may be achieved. For example, the pcap interpreter 322, netflow handler 324, syslog parsers, etc., may not need to interact with each other. In addition, the various output streams may also not need to interact. During installation, the pieces that are part of that installation may only need to be installed. For example, a system that does not use netflow may not need to interact with the syslog code and processes, which may reduce coding errors and the attack surface of Sophia.

Sophia may further include additional features. For example, Sophia may include a command line interface for control, which may be used for interacting with remote servers running Sophia, or setting up scripts to interact with Sophia. Sophia may further include creation of various output records and streams, such as syslog during execution, which may allow additional processing of Sophia records. Sophia may further include a distributed architecture, which may be desirable for some systems that are too disparate to monitor using a single server. Sophia may further be configured to store at least some history of the data it receives, which may be useful for event re-creation. The stored data may allow the user to track the cause of alerts and possibly help during a forensics investigation.

Sophia may further be configured to operate with substantially zero downtime. As a result, Sophia may include multiple levels of redundancy. In addition, Sophia may be configured to support being started as a service at boot time. Sophia may be configured to handle dynamic service ports, which may otherwise currently break the fingerprinting system or create a very large fingerprint that is not an accurate representation of the actual activity.

Sophia may be further configured to forward received data. For example, a network interface card may be allowed to receive span traffic and recreate the span traffic on another card so that another server has access. On many switches, span ports may be a limited resource. Sophia may be configured to include security measures, such as privilege dropping and set user ID (SUID) executable instead of running Sophia as root, and running Sophia in a chroot environment. Other security measures are contemplated.

Sophia may be further configured to passively monitor and learn about the components and communication pathways in an ICS network. For example, Sophia may monitor a span port using libpcap, or parse syslog records to learn about the devices and communications on an ICS network. Sophia may be configured to capture a baseline fingerprint of a system and detect deviations from the fingerprint resulting in alerts for the user, such as through an interface that supports a one-click method of baselining a system.

Sophia may be configured to provide information that is used to build quality firewall rules. For example, Sophia may provide several ways to inspect the fingerprint to facilitate firewall rule development including a permutable tree structure and comma-separated value (CSV) file exportation for offline analysis.

Sophia protocols may be designed with built-in security. In addition, the core Sophia process code may be configured to expand its fingerprinting capabilities. For example, Sophia may track its communication periodicity, as well as provide communication correlation. Periodicity tracking may track how often certain communications occur, provide time span summation of the occurrences and provide an alert when a communication fails to respond within a predefined dead band of periodicity. Providing correlation may detect communications and devices that are related, such as server redundancy.

In operation, Sophia may provide a real-time application that fingerprints a running network (e.g., an ICS, such as an ICS operated by a utility company) and monitors communications on the network for deviations from the fingerprint. In addition, several other use cases are contemplated. For example, embodiments of the present disclosure may be employed to: monitor an ICS and generate an alert based on deviation from the established fingerprint; monitor an ICS system during deployment and use the conversation records as a basis for firewall rules during integration; fingerprint an ICS system at the vendor stage and then monitor that system during deployment for changes; fingerprint a QA system at the vendor stage and compare that fingerprint to a deployed system to help identify changes in the deployed system; use fingerprints from Sophia to program switches, routers, and firewalls; and harden ICS components by disabling unnecessary services that have been identified by Sophia. Other use cases are further contemplated.

In some embodiments, to allow quick initial use, Sophia may support a fingerprinting mode that classifies all pathways as valid until the user decides that the fingerprint is complete. Deviations from this accepted baseline generate alerts that allow the user to maintain awareness, examine validity, and respond appropriately. Sophia stores information about the network in records of several types. A “host” record is defined as a unique Internet Protocol (IP) address. A “service” record is uniquely defined by a host and service port. A “channel” record is uniquely defined by a service and another host acting as a client. A “session” record is uniquely defined by a channel and a client port. A “conversation” is a broad term that is the compilation of a plurality of distinct record types, such as a service, channel, and session.

FIG. 4 depicts these relationships as a permutable tree structure 400. The information may be extracted from live packet data using a tool such as, for example, libpcap or for historical data stored in a file such as, for example, a pcap file.

From the raw packet data, Sophia may extract channel and IP host records. This database of records forms the core of a SCADA network fingerprint. After a representative amount of time has passed, the user may instruct Sophia to lock this database. From that point on Sophia may use the database to generate alerts on anomalous network traffic and provide the user a means to fine-tune the database.

Sophia stores information about the network in a variety of types of records. In FIG. 4, the boxes of the permutable tree structure 400 represent records stored by Sophia. For example, Sophia may store records as a host record 410, a service record 420, another host record 430, a channel record 440, and a session record 450. The diamonds of the permutable tree structure 400 represent unique information (e.g., parameters) that each record includes. For example, the host record 410 includes an IP address 415 of a host and the service record 420 includes a service port identifier 425 along with information from the host record 410. The other host record 430 includes an IP address 435 of another host and the channel record 440 includes information from the service record 420 and the other host record 430. A conversation may be referred to herein as interaction between two hosts as identified by the information in a channel record. The session record 450 includes a client port identifier 455 and information from the channel record 440. In addition to unique information, records may store other information, such as, for example but without limitation, bytes sent and received, transmission errors, transmission retries, and information to identify various types of communication protocols.

As Sophia monitors communications on a network, each communication may include a plurality of parameters that identify information of the communication. In other words, a single communication may include more than the four parameters of the conversation, as shown in FIG. 4. Non-limiting examples of such additional information include bytes and packets both sent from and received by a host; failed attempts to contact a host; failed attempts by a host to contact other hosts; the IP address type (e.g., Unicast, Broadcast, or Multicast); the color of the host (i.e., white, black, grey); and the last time the host was observed.

In operation, Sophia may limit what is being monitored by recording a small subset of the overall parameters of the communication. There may be, however, many communication sessions with the same four parameters that are monitored and recorded by Sophia. By further combining all identical sessions into a single channel, the connectivity and communication conversations that need to be represented are greatly reduced.

Therefore, Sophia may include a method for organizing and displaying desired network communications based on permutable organization of parameters, such as client IP address, service port, server IP address, and protocol, among others. The method may merge multiple sessions with the same communications parameters into a single “channel.” In addition, channels can provide a method to simplify the complexity of the data into an easy-to-interpret view for better situational awareness by including the client port to comprise a session.

With the records generated by Sophia, a baseline may be created. When creating a baseline, the goal is to find a static set of data that can always be applied. In a control system, the channel concept may be desirable for creating a static baseline; however, it may not be as desirable in an Internet-enabled network. Conventional network environments rely heavily on the concept of sessions. For example, the state in a “statefull” firewall is based on session tracking. For embodiments discussed herein, a session is defined by a set of the same parameters as a channel, plus the client port identifier 455. In Internet-enabled networks both the client port and the server IP are highly dynamic and will prevent the channels from forming a static baseline set. In a control system, however, only the client port is typically dynamic. As a result, the channel data set becomes static in size relatively quickly allowing for the creation of a baseline.

Depending on the goal of the user, the channel data may need to be organized in different ways. Instead of presenting preset organizations of the channel data, the permutable tree structure 400 allows the user to permute the node levels to best fit their current need. The permutable tree structure 400 may include related elements that are related, such as, for example, through identified conversations. As a non-limiting example, these related elements may include a server address, a client address, a protocol identified for a conversation between the server and the client, and a service port identifier for the server.

For example, the user may want to learn about the services that a particular host provides. With conventional databases or tables, the user would need to enter in a complicated query that specifies the host as the server and sorts based on protocol, port, and then client IP address. With the permutable tree structure 400, however, the user simply permutes the tree into a desired order of: server IP address, protocol, service port, client IP address and the data then may be displayed in an optimized way for finding information about the services provided by a host.

As described above, a session is defined as a channel plus another piece of unique information (e.g., client port identifier 455), and there are often many sessions that all reference the same channel. Similarly, many channels may all reference the same service.

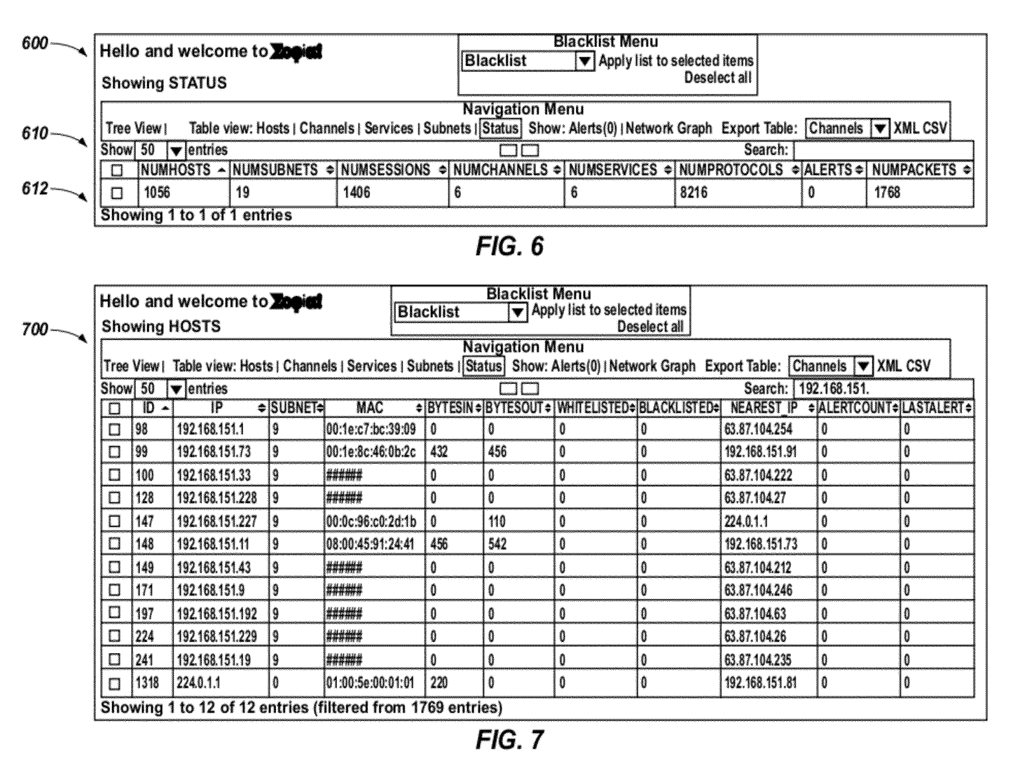

FIG. 5 is a diagram illustrating a conversation composition according to an embodiment of the present disclosure. The conversation 500 depicts a top-down perspective of a service 510 that includes one or more channels (520A, 520B, 520C), with each channel 520 including one or more sessions (530A, 530B, 530C, 530D, 530E, 530F).

Sophia may employ a GUI that may be simple and takes little time to learn. For example, the GUI may be Web-based, such as CHROME®, FIREFOX®, INTERNET EXPLORER®, etc. The GUI records, organizes, and displays the ICS conversations in an organized manner (e.g., tables, trees, etc.), and allows the user to identify each pathway as “appropriate” or “non-appropriate.”

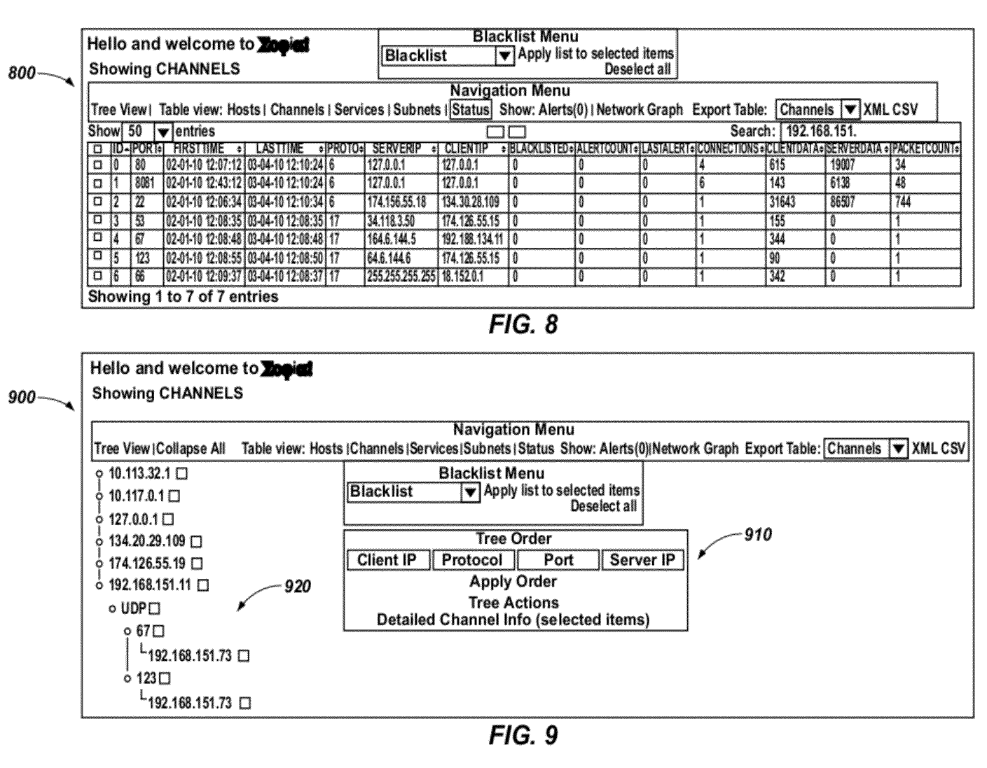

FIGS. 6-13 are non-limiting examples of GUIs for Sophia that may be used to access, analyze, or otherwise process data collected by Sophia. Sophia may provide an XML API for use by software not directly involved in traffic analysis. The GUIs of Sophia may use the API to create dynamic Web pages for the user. As a result, Sophia data can be accessed from a Web browser, such as Chrome, Firefox, etc. Security may be handled, for example, by limiting the Web server to localhost-only connections or through other security measures.

FIG. 6 shows a status page 600 of Sophia according to an embodiment of the present disclosure. The status page 600 includes at least one table 610 to display information about Sophia. As a non-limiting example, row(s) 612 in the table 610 lists the number and type of items Sophia has detected. For example, Sophia has identified 1406 sessions that are organized into six channels. In FIG. 6, each channel fits into a different service since there are also six services listed in the table 610. Other information such as the number of hosts, subnets, protocols, alerts, and packets may be displayed by the table 610.

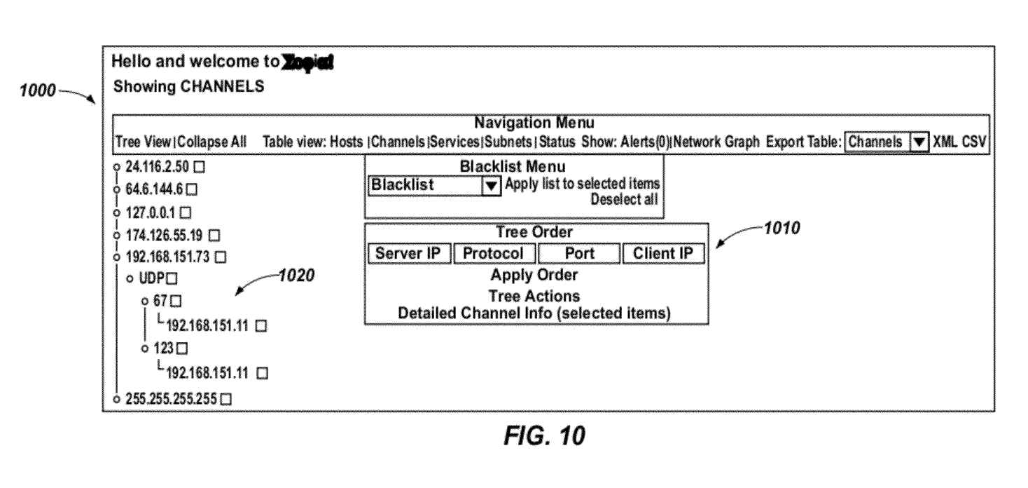

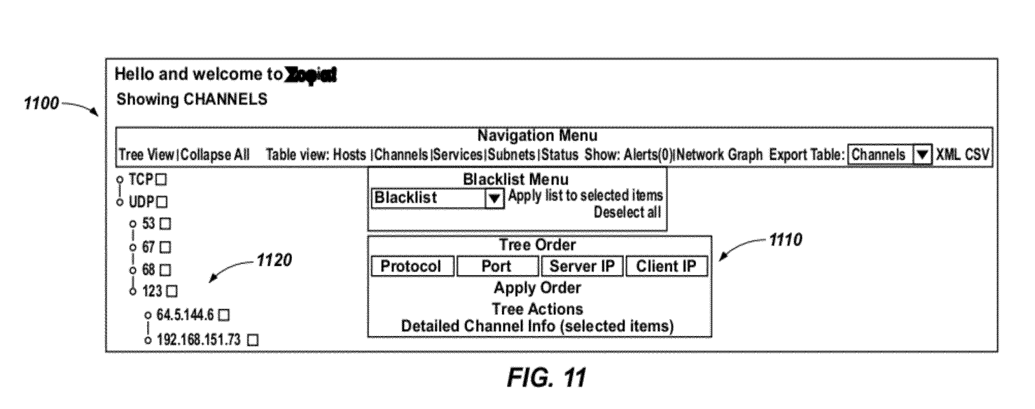

Sophia may further provide individual table views for each of its record types. For example, FIGS. 7 and 8 are table views for hosts (i.e., host table 700) and channels (i.e., channel table 800), respectively. Hosts and channels may be particularly useful forms of information kept by Sophia. Referring to FIG. 7, the host table 700 roughly produces a list of devices found on the network. Referring to FIG. 8, the channel table 800 is displayed. Channels may be more succinct than sessions. For example, a single Web browser may produce thousands of sessions even when only connecting to a single server. All of those sessions to the same server may be collected into a single channel. Channels provide information about both end points of a conversation, whereas a service may store information about only one end point. Therefore, a channel can be identified as crossing subnet boundaries.

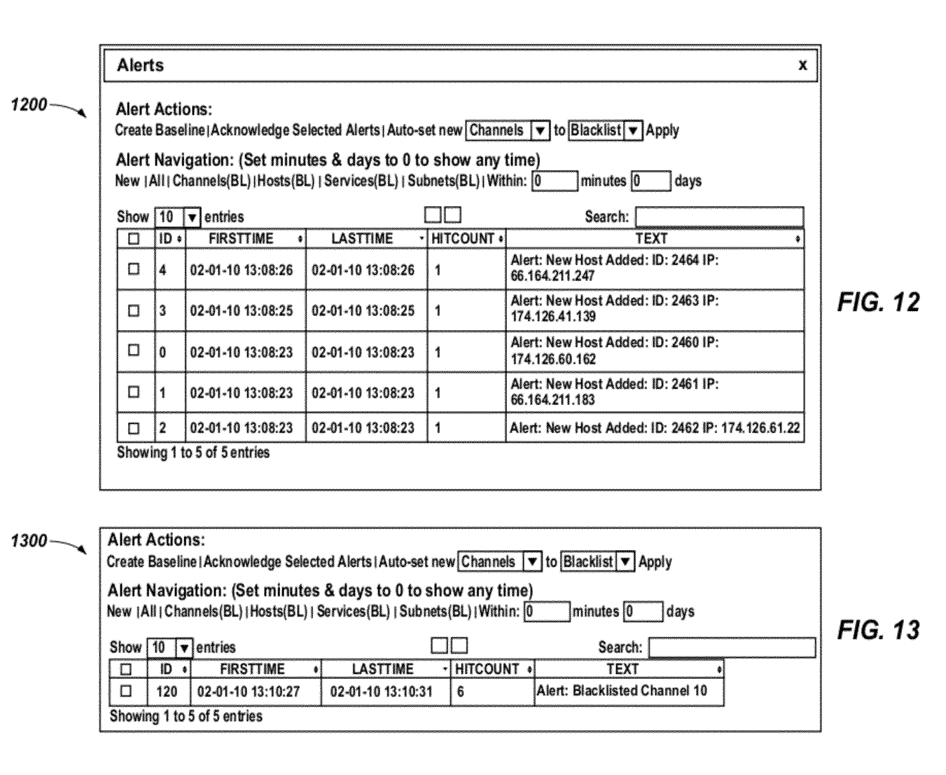

FIG. 9 is a GUI depicting a channel tree view 900 that allows the user to explore a system by organizing the channels into different trees. Two related questions often arise during an assessment of a communication: “What are all of the communications leaving this client?” and “What are all of the communications coming into this server?”

If the tree order 910 is set to “Client IP”: “Protocol”: “Port”: “Server IP”, the client tree may be expanded for the client in question. For example, the channel tree view 900 of FIG. 9 shows an expanded tree 920 for client “192.168.151.11,” which is using Dynamic Host Configuration Protocol (DHCP) services (identified by “67”) and Network Time Protocol (NTP) services (identified by “123”), both from Server “192.168.151.73.”

FIG. 10 illustrates a GUI 1000 showing a tree order 1010 set to “Server IP”: “Protocol”: “Port”: “Client IP.” An expanded tree 1020 for the desired server, shows that the server at IP address 192.168.151.73 is providing DHCP services (67) and NTP services (123) to a client at IP address 192.168.151.11.

Another often asked question is “Which hosts are using a certain protocol?” FIG. 11 shows that a channel tree view 1100 can be organized in a tree order 1110 “Protocol”: “Port”: “Server IP”: “Client IP,” which may result in quickly obtaining a list of servers servicing a specific protocol. In this case, an expanded tree 1120 shows that NTP services (123) are being provided by a host at IP address 64.6.144.6 and a host at IP address 192.168.151.73.

As previously discussed, passive record collection performed by Sophia generates a fingerprint of the known system. After the user operates in fingerprint mode long enough to collect a representative operation of the known system, the user may have the option to create a baseline fingerprint. The baseline fingerprint may be defined such that all current records may be organized into a “white list” indicating that the record identifies information that is in an acceptable traffic category (e.g., not a threat to the network or represents otherwise acceptable network devices or communications). In other words, these communications may be designated as acceptable and normal. Alternatively, the user may select each record and specifically identify whether it should be placed on the white list, a grey list, or a black list. The grey list indicates the record needs more evaluation and may also be referred to herein as an undetermined traffic category. The black list indicates that the record includes information about network devices are in an unacceptable traffic category (e.g., communications that may be a threat to the network or represent otherwise unacceptable network operations).

If a new communication or abnormal communication is detected it will be “grey listed,” and Sophia may generate an alert notifying the user that an anomalous conversation has appeared on the network and the user should address its arrival. The grey list may also be referred to herein as an undetermined traffic category. The user may also determine whether the anomalous conversation should be placed on the white list, black list, or remain on the grey list for further analysis at a later time.

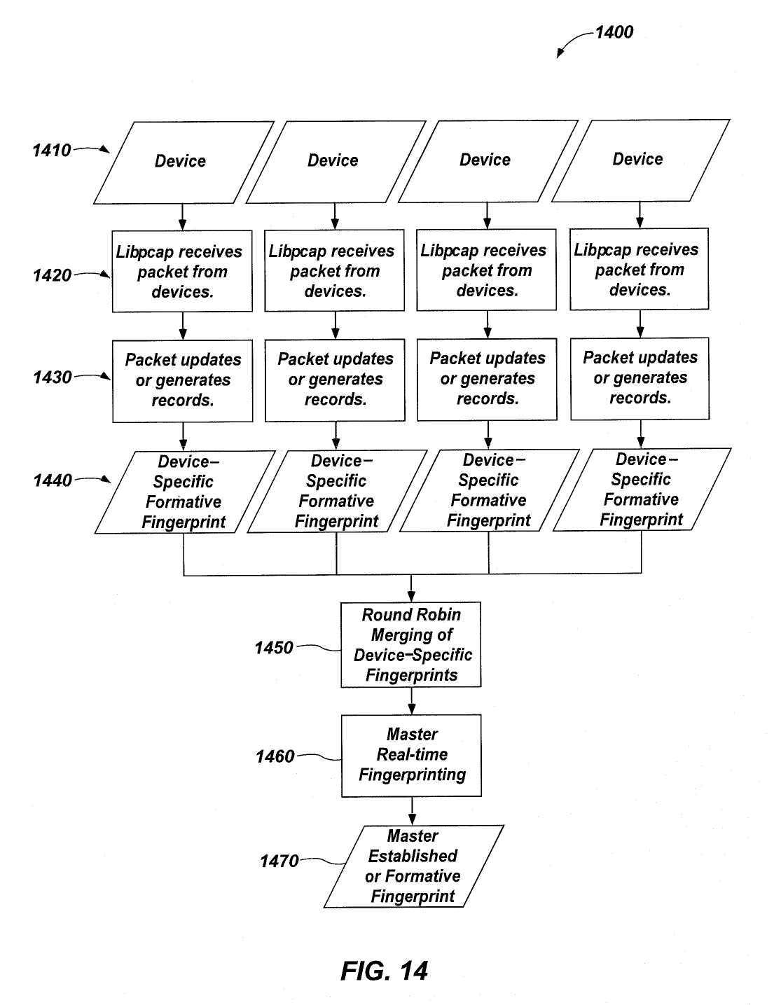

FIG. 12 is a GUI 1200 configured to display new host alerts generated by Sophia after creating a baseline fingerprint. At this point, it may be desirable for the user to investigate the new communication and decide if the communication is appropriate or inappropriate for the ICS. If the communication is appropriate, the user can add the records to the white list and acknowledge the alert. If the communication is inappropriate, the user can add the records to the black list and acknowledge the alert. The user may want to further follow up on an inappropriate communication by fixing the problem that caused the alert. In such a case, the user can add the records to the grey list and acknowledge the alert.

New communications may appear after the baseline has been created for a variety of different reasons. For example, appropriate reasons may include: a new device (e.g., a new database server) may have been added to the network and should be documented as such; there may be a failover (e.g., the primary and secondary servers have switched roles resulting in new traffic patterns); and there may a software update (e.g., the vendor may have recently updated the real-time database and a new Transmission Control Protocol (TCP) port shows up on the server). Inappropriate reasons may include: a device failure (e.g., a server's hard drive may fail, causing the network configuration file to be lost and the IP address of the server has changed as a result); there may be an intruder (e.g., an intruder has gained a foothold on the network and is scanning the network as part of the intruder's reconnaissance); and WINDOWS® updates may have occurred (e.g., WINDOWS® may have decided to reactivate automatic updates and it is trying to reach Microsoft's update servers). Of course, it is contemplated that there are other reasons and causes of appropriate and inappropriate communications.

If the user white lists the record, no further action may be required. If, however, the user black lists the record, Sophia will begin generating alerts every time that record is reconfirmed with traffic on the network.

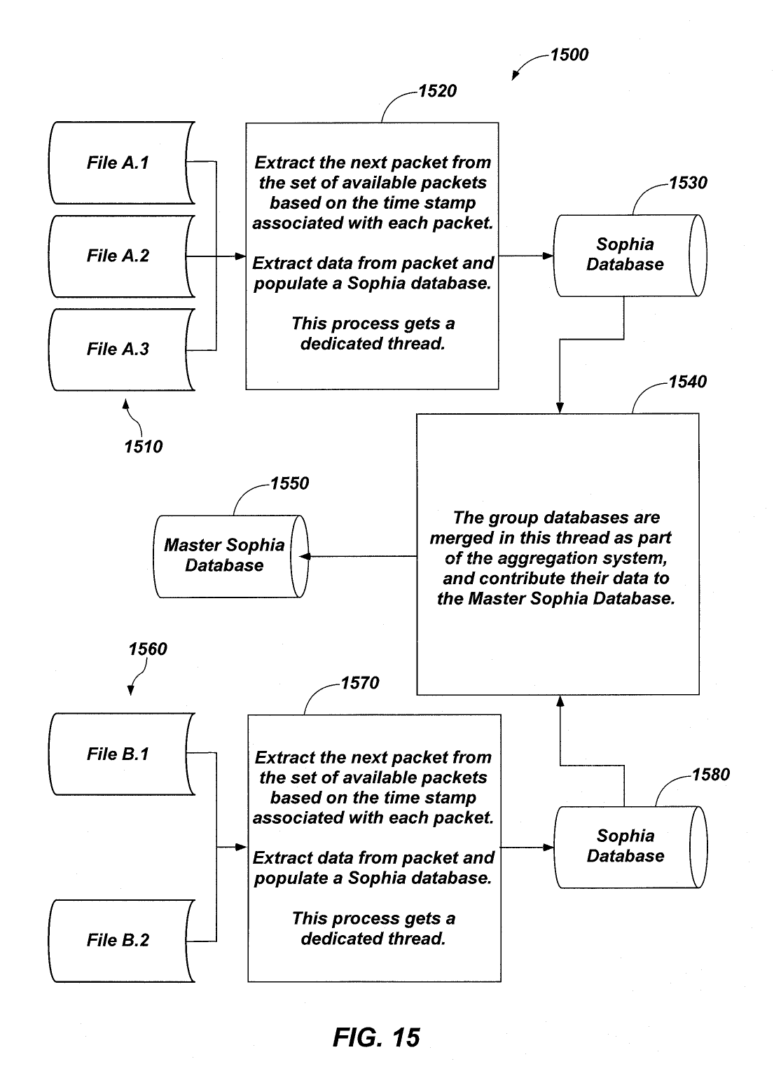

FIG. 13 is a GUI 1300 that shows an example of an alert generated from a black-listed channel. As shown in FIG. 13, from the time of the channel's black listing, Sophia has detected six packets as part of that channel. Black-list alerts are useful to notify the user that a problem has reoccurred after the first event that caused the blacklisting.

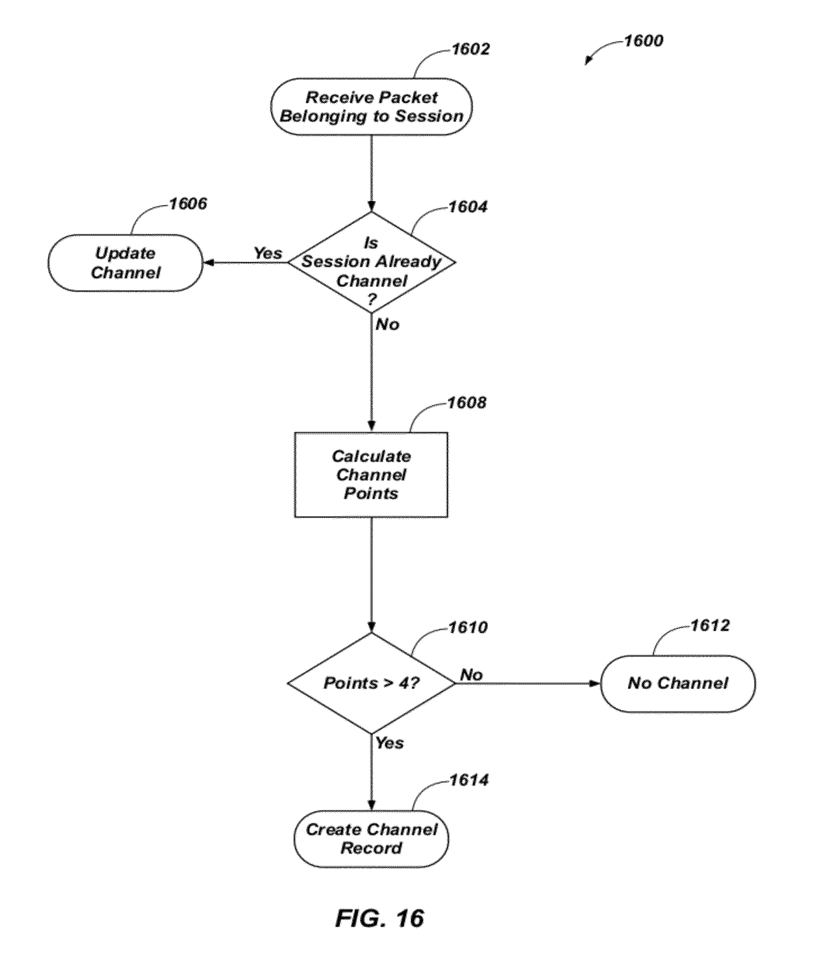

FIG. 14 is a flow diagram illustrating a process 1400 for merging device-specific records from substantially real-time capture into a fingerprint. When using real-time data captured from a device, Sophia creates device-specific databases that are able to process the data from each device independently and at a high speed. These device databases are then merged into the master Sophia database at a speed that causes little to no performance degradation of the devices. At level 1410 a variety of network monitoring systems may be placed at various points in a network to monitor communications on the network. In the case of FIG. 14, four parallel paths are illustrated for four different devices. Information from the network is monitored by these high-speed devices in a substantially passive manner to reduce any performance impact on the network due to the monitoring.

Level 1420 indicates that packets are received from the devices, such as, for example, in a libpcap format. Level 1430 indicates that received packets are used to update or generate any of the records identifying conversations on the network as described above with reference to FIG. 4. Level 1440 indicates that the updated or generated records may be included in a fingerprint database specific to the device from which the packets were captured.

Operation block 1450 indicates that a round-robin process may poll each of the parallel paths to gather and assemble the device-specific fingerprints from each parallel path. Operation block 1460 indicates that the device-specific fingerprints may be combined into a master real-time fingerprint for the network as the packets are processed.

Operation block 1470 indicates that the master real-time fingerprint may be defined as an established fingerprint or a formative fingerprint. Embodiments of the present disclosure may define different types of fingerprints for different situations. As a non-limiting example, a network fingerprint may be defined as a static fingerprint, a real-time fingerprint, an established fingerprint, or a formative fingerprint. Any of these fingerprints include the classifications (also referred to herein as colors) as identified above for white, grey, and black conversations.

The static fingerprint is a fingerprint that is not changing and may include a database of observed traffic on the network up to a certain point in time. The real-time fingerprint changes as the network changes and new packets are captured and analyzed. Alerts may be generated whenever a blacklisted item is observed.

The established fingerprint is a real-time fingerprint that may include a database of communications on the network that have been observed. All other new communications and devices may result in an alert.

The formative fingerprint is a real-time fingerprint that automatically adds new devices and communications to the database.

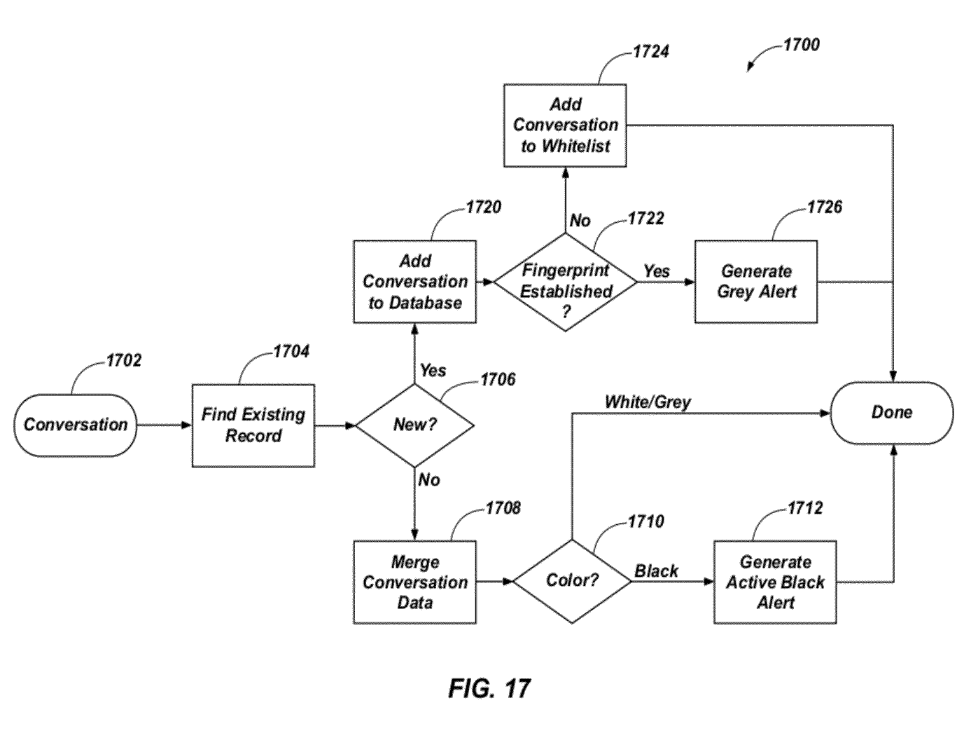

FIG. 15 is a flow diagram illustrating a process 1500 for merging information from historical files into a master database. When using historical data, such as, for example, from pcap files, embodiments of the present disclosure use a hierarchy of files to define the best possible fingerprint and performance. Related files may be grouped and processed synchronously to achieve an accurate fingerprint. Each group may be processed asynchronously. A first group of files 1510 may be processed together as indicated by process block 1520. In this operation, a next packet from available packets in the files is extracted based on a time stamp for the packet, and the packets are processed to create appropriate records as described above with respect to FIG. 4. For optimal processing, the operations of process block 1520 may be performed in a dedicated thread. A group database 1530 holds results of the processed records from process block 1520.

In a similar manner, a second group of files 1560 may be processed by process block 1570 and placed in another group database 1580. Operation block 1540 indicates that the group databases (e.g., 1530 and 1580) may be merged as part of an aggregation system and placed in a master fingerprint database 1550.

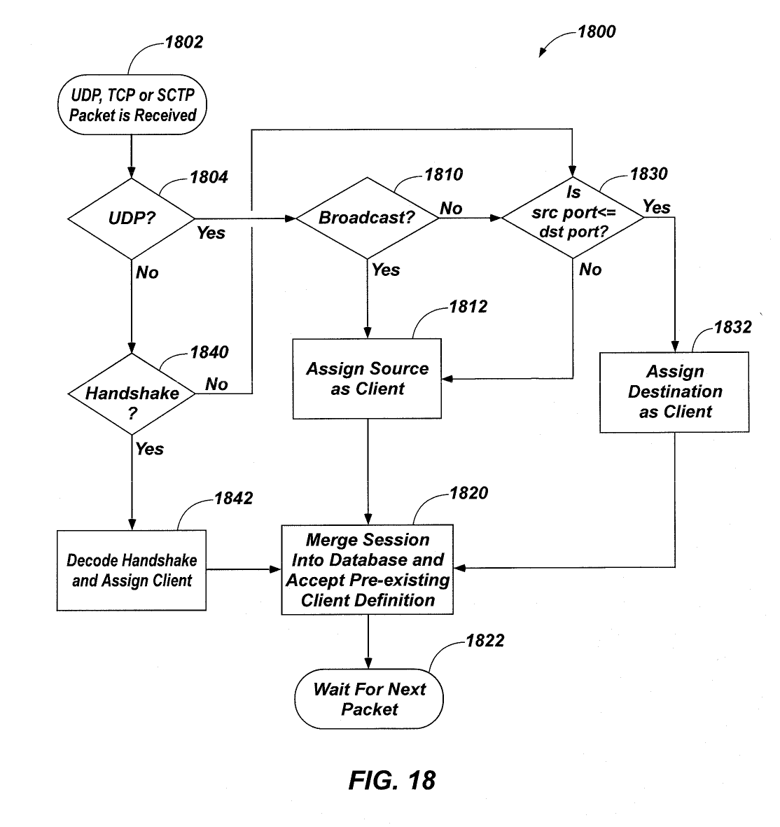

FIG. 16 is a flow diagram illustrating a process 1600 for identifying a valid channel. A channel is a conversation between devices and may be defined by four characteristics: a server IP address, a client IP address, a protocol used in communications between the server and client, and a server port associated with the server.

Embodiments of the present disclosure may track information such as, for example: packets and bytes for both directions of the conversation, the number of sessions that are a part of this channel, the color of the channel (e.g., white, grey, black), and the time that the channel was last observed.

Block 1602 indicates that a new packet is received that belongs to a particular session. Decision block 1604 indicates a test to determine if the session is already defined as part of an existing channel. If so, block 1606 indicates the channel may be updated with the new packet information and the process 1600 ends.

If the session is not part of an existing channel, operation block 1608 indicates that points may be assigned to a nascent channel based on the type of communication in the received packet. The process 1600 may keep a database of nascent channels that have not yet been completely identified as a channel. Each time the process 1600 is executed with a new packet, the packet may be identified with a specific nascent channel and any points identified with the current packet being operated on may be added to previous points for the nascent channel. Thus, operation block 1608 indicates the accumulation of channel points for the nascent channel.

Decision block 1610 indicates that a test is made to see if a point threshold (e.g., four points) is met to identify a channel. If so, block 1612 indicates that the process 1600 exits without identifying a new channel. If the point threshold is met, block 1614 indicates that a new channel record is created for the nascent channel and the nascent channel may be removed from the list of possible channels.

As a non-limiting example, one embodiment may assign different point levels to different types of packets. For example, an ACK flag from a TCP packet from one host may be assigned one point, a User Datagram Protocol (UDP) packet may be assigned one point, and a UDP broadcast may be assigned four points.

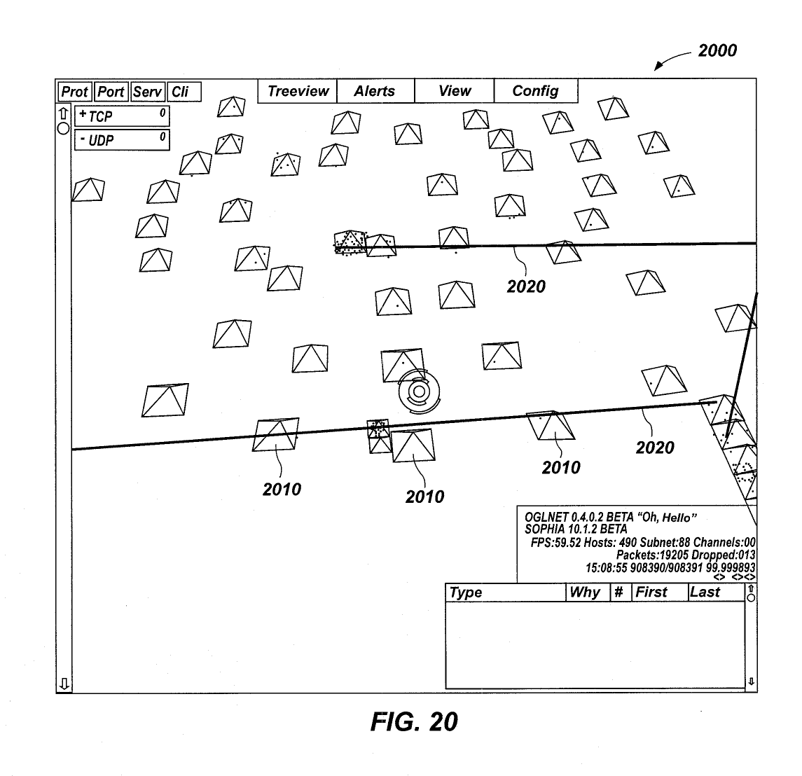

After determining which host is the server and which host is the client (see the discussion of FIG. 18 below), embodiments of the present disclosure may then remove the client port from the defining characteristics and create a channel. However, not all packets justify creating a channel. For instance a host could be performing a network scan and generate many packets that do not represent legitimate conversations.

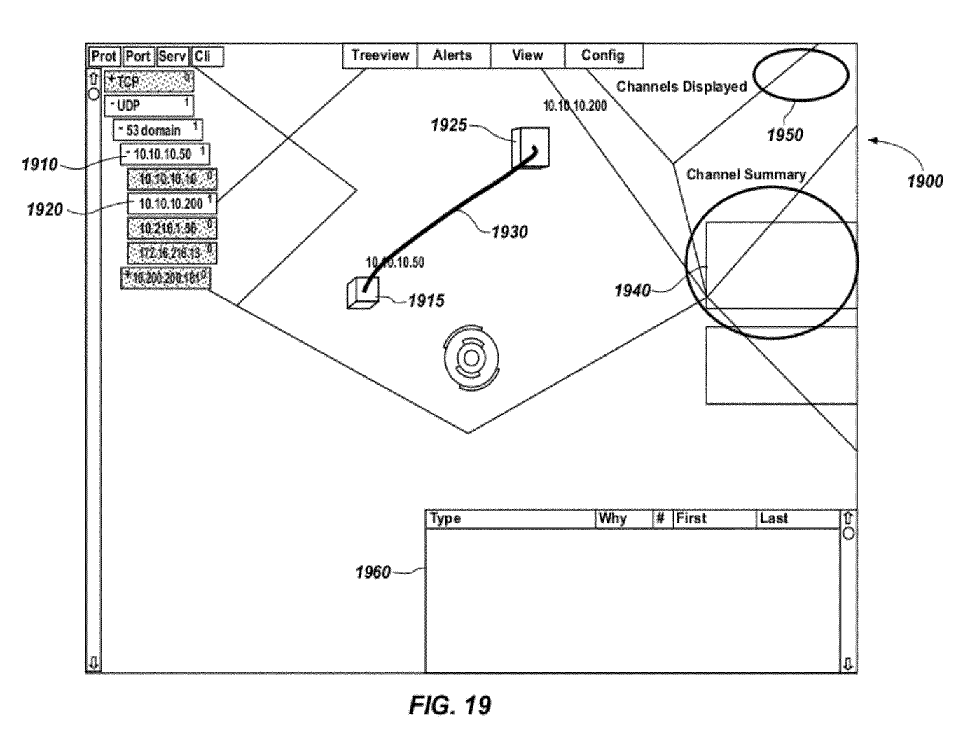

FIG. 17 is a flow diagram illustrating a process 1700 for generating alerts for new conversations and abnormal conversations and devices. Embodiments of the present disclosure may maintain a real-time fingerprint of acceptable network devices and conversations. Process 1700 illustrates an embodiment of how the fingerprint can be established and alerts can be generated based on the established fingerprint. Block 1702 indicates that a conversation is used as an input to the process 1700. Operation block 1704 indicates that a check is made to find if there is an existing record related to the conversation. Decision block 1706 indicates a test to see if the conversation is new (i.e., does not have an existing record related to the conversation). If the conversation is new, operation block 1720 indicates that it is added to the fingerprint database. Decision block 1722 tests to see if there is already a fingerprint established. If there is no established fingerprint, operation block 1724 indicates that the conversation is added to the whitelist and the process ends. If there is a fingerprint established, operation block 1726 indicates that a grey alert is generated and presented to the user for further analysis by the user and the process 1700 ends.

Returning to decision block 1706, if the conversation is not new, operation block 1708 indicates the conversation is merged in with other data to update the conversation. Decision block 1710 indicates a test to determine a color of the updated conversation. If the conversation is considered white or grey, the process 1700 ends. A white conversation would normally need no alert to the user and if the conversation is already grey, presumably the user knows about it or can review the grey list to examine it. In an alternative (not shown), the process may determine that even though this is an existing conversation, a new grey alert may be generated to the user.

If the conversation is considered black, operation block 1712 indicates that a black alert is generated and presented to the user for further analysis by the user and the process 1700 ends. In general, alerts indicate that something new or unacceptable has occurred. As a non-limiting example, an alert may include three characteristics: the record source type (e.g., host or channel), the ID of the source, and the reason for the alert (e.g., new behavior or known bad behavior).

FIG. 18 is a flow diagram illustrating a process 1800 for estimating a client-server relationship from a single packet of a session. A client and server relationship is not always obvious. Embodiments of the present disclosure may use this process 1800 to make a “best guess” determination on the client and server identities for applicable packets. Which device is the server and which device is the client is relatively easy to determine if initiation of communication between the two host devices is captured. However, embodiments of the present disclosure are configured to operate in an existing network and begin capturing packets in the middle of conversations. In such cases, determining the server and the client is more difficult. Some embodiments of the present disclosure estimate the client-server relationship using a single packet of a session between two hosts. Block 1802 indicates that the process 1800 begins when a new packet is received, which may be in a variety of formats, such as, for example, UDP, TCP, and Stream Control Transmission Protocol (SCTP).

Decision block 1804 indicates a test to determine if the packet is a UDP packet. If so, decision block 1810 indicates a test to determine if the UDP packet is a broadcast type packet. If so, operation block 1812 indicates that the source of the packet is defined as a client and control passes to operation block 1820, which is discussed below.

If the UDP packet is not a broadcast type packet, decision block 1830 indicates the source port identifier is compared to the destination port identifier. In most networks, server devices are assigned lower port identifiers than client devices. As a result, if the source port identifier is less than the destination port identifier, operation block 1832 indicates the destination is defined as the client, otherwise operation block 1812 indicates the source is defined as the client. In either case, after defining the client, control passes to operation block 1820, which is discussed below, then block 1822 indicates that the process 1800 waits for a next packet before the process 1800 begins again.

Returning to decision block 1804, if the packet is not a UDP packet, decision block 1840 determines if the packet includes handshake information. If not, control transfers to decision block 1830, as discussed above.

If the packet includes handshake information, operation block 1842 indicates that the handshake information is decoded and from this information, the source or destination can accurately be assigned as the client.

Operation block 1820 indicates that after the client is assigned, the client information is merged into the existing database and a pre-existing definition for the client is used. In other embodiments, the new client definition may be used instead of the pre-existing client definition.

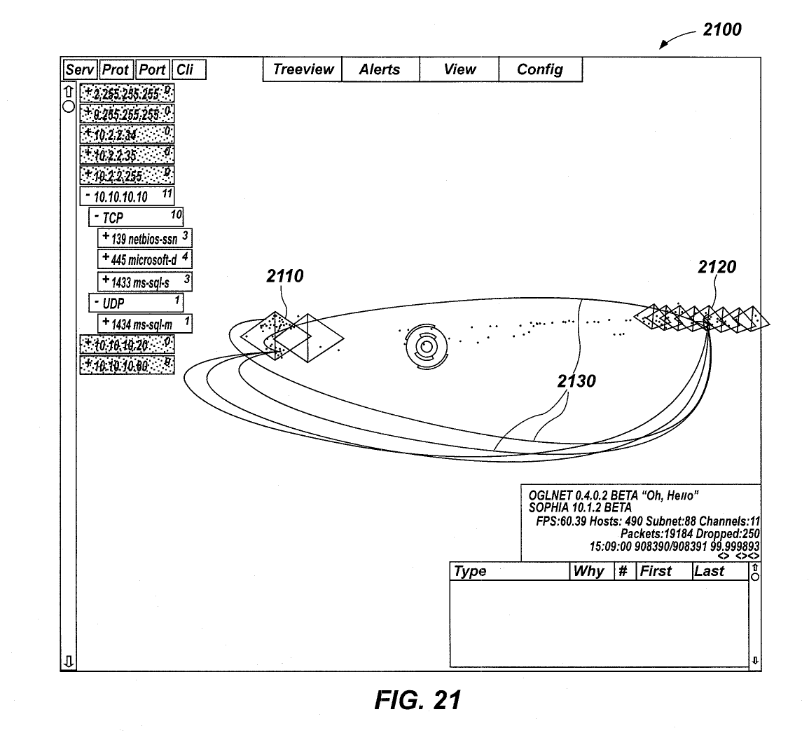

FIG. 19 illustrates a GUI 1900 including a three-dimensional environment with graphical elements correlated with selections in a permutable tree structure. Some embodiments of the present disclosure may synchronize a 3D rendering of the network fingerprint with the 2D channel tree selections.

The user can then mouse hover over a single channel tree entry in order to get it to pulse in the 3D network fingerprint. This allows the user to find that particular channel among the set of selected channels without removing the other channels from the rendering.

The permutable tree structure is illustrated on the left side of the GUI window. Within the permutable tree structure, highlighting indicates the user has selected a first host 1910 identified with the IP address 10.10.10.50. Highlighting also indicates the user has selected a second host 1920 identified with the IP address 10.10.10.200. The three-dimensional environment to the right of the permutable tree structure includes a graphical representation 1915 of the first host 1910 and a graphical representation 1925 of the second host 1920. Line 1930 between the graphical representation 1915 and the graphical representation 1925 indicates a channel between the first host 1910 and the second host 1920. Region 1950 indicates a region that may include additional information about the channels that are currently displayed. In addition, the channel 1930 has been selected and highlighted by the user. As a result, region 1940 indicates additional information that may be available for selected channels. Region 1960 may be included to present alerts related to the fingerprint process explained above.

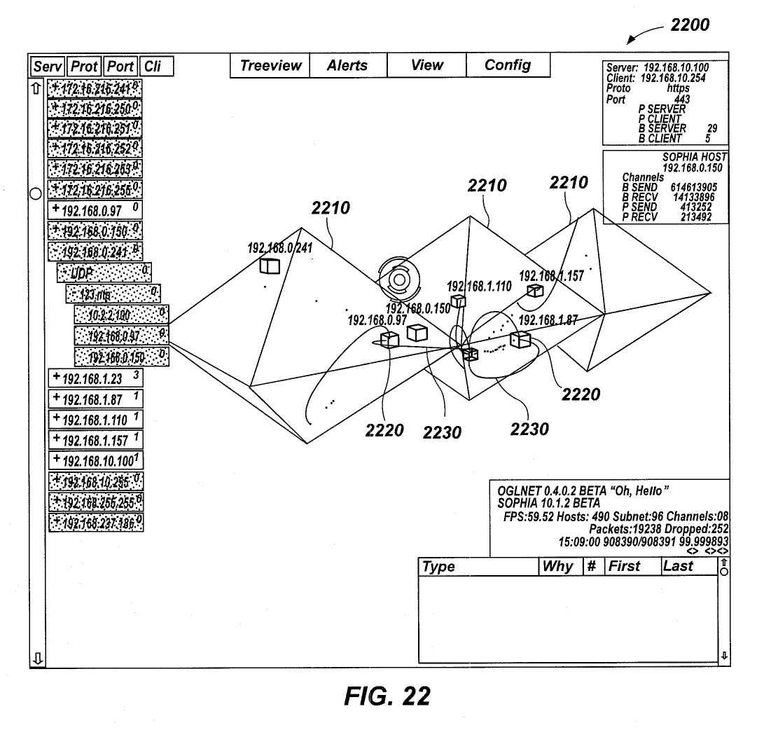

FIG. 20 illustrates a GUI 2000 including a three-dimensional environment with a baseline layout of icons representing sub-networks and hosts and illustrating packets as animated lines connected between hosts. Sub-networks 2010 may be identified as hosts that are related to each other within a specific network such as, for example, a specific SCADA network or a specific ICS network. Identification of these sub-networks 2010 may be an automated process, a user process, or a combination thereof.

When a three-dimensional environment is first built and includes hosts (illustrated as small dots individually or within sub-networks 2010) and sub-networks 2010, they may be populated in the 3D environment on a baseline plane. In addition, they may be laid out in somewhat of a spiral with newer elements being placed farther away from a center point of the baseline plane.

Lines 2020 indicate packets communicating between hosts. These packets may be animated in a number of ways. As a non-limiting example, the packets may be illustrated as lines that fade in and fade out over time indicating the packet transmission. As another non-limiting example, the packets may appear as dots that traverse from one host to another over time indicating the packet transmission.

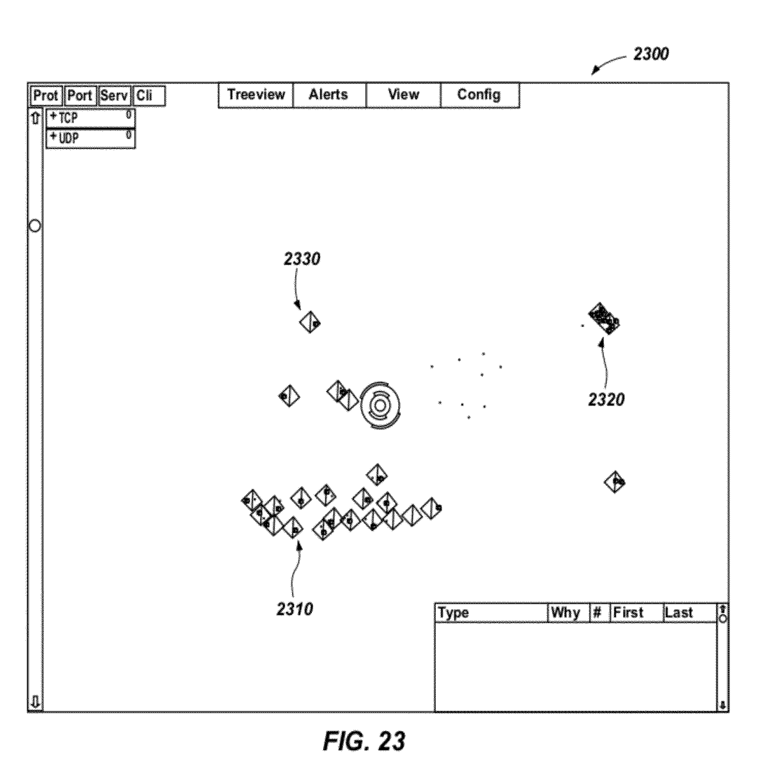

FIG. 21 illustrates a GUI 2100 including a three-dimensional environment with graphical elements correlated with hosts, and channels between some of the hosts. In FIG. 21, channels are illustrated as curved lines 2130 connecting two hosts that are participating on the channel. For clarity, only some of the curved lines have been identified with element numbers. The curved lines 2130 representing channels are in contrast to the straight lines 2020 of FIG. 20 that generally represent packet transmissions. A first sub-network 2110 illustrates a number of hosts (illustrated as small dots) within it. A second sub-network 2120 illustrates a number of hosts (illustrated as small dots) within it. The curved lines 2130 illustrate channels between the two sub-networks 2110 and 2120. Moreover, the channels illustrated are correlated to selected channels in the permutable tree structure on the left side of the GUI 2100. In some embodiments, the channels may be configured to pulse to illustrate traffic that may be flowing on the channel. With reference to FIGS. 20 and 21, the curved lines 2130 illustrating channels, the straight lines 2020 illustrating packets, and the moving dots illustrating packets (not shown) may be presented in different colors to indicate different types of protocols that may be associated with the respective channels and packets.

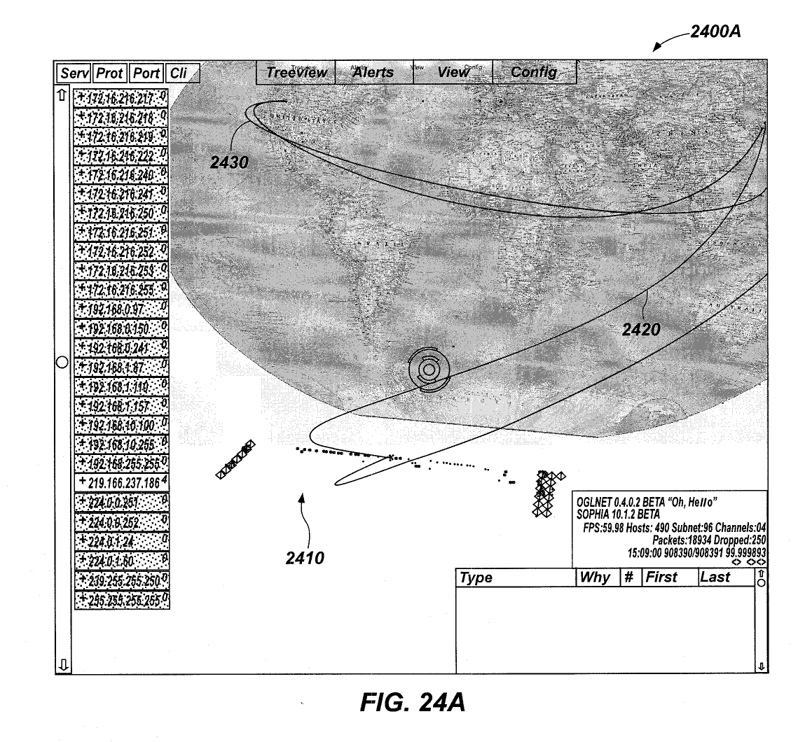

FIG. 22 illustrates a GUI 2200 including a three-dimensional environment with graphical elements correlated with selections in a permutable tree structure and including sub-networks, hosts, and channels. The pyramid structures 2210 are graphical representations of sub-networks. The cube structures 2220 are graphical representations of hosts within the sub-networks. The curved lines 2230 illustrate channels between the hosts. Each of the hosts illustrated by a cube structure 2220 is correlated to a host selected in the permutable tree structure shown at the left of the GUI 2200. For clarity, only some of the hosts and channels have been identified with element numbers.

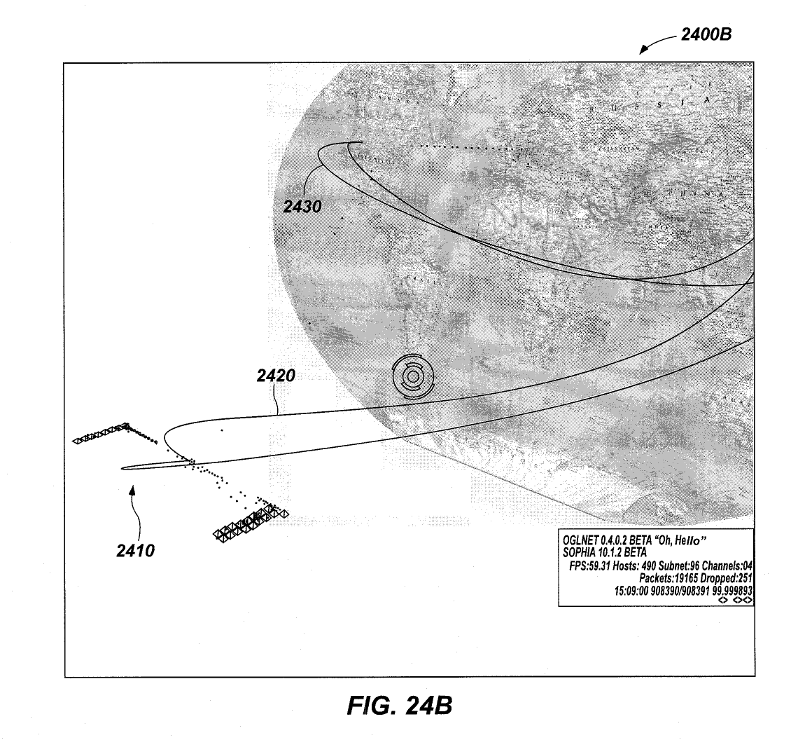

FIG. 23 illustrates a GUI 2300 including a three-dimensional environment with graphical elements illustrating a bubble-up process. Bubble separation may be used to let sub-networks that participate in network traffic to “bubble” up to the top of the 3D environment for easy identification. As a non-limiting example, each time a host within a sub-network sends a packet, that sub-network may rise a little bit in a direction that is substantially perpendicular to a baseline plane. Region 2310 illustrates the baseline plane with a number of sub-networks that have very little network traffic associated with them. Sub-networks 2320 and 2330 illustrate sub-networks that have risen above the baseline plane due to many packet transmissions associated with hosts within each of the respective sub-networks. This bubble-up process provides an easy graphical representation to the user of which sub-networks are more active.

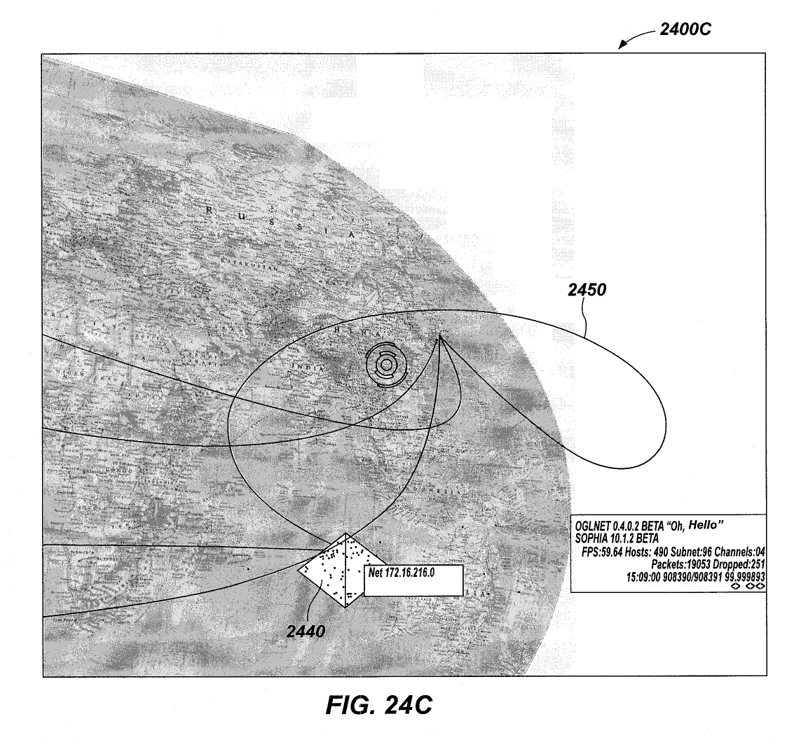

FIGS. 24A-24C illustrate a GUI (2400A-2400C) including a three-dimensional environment illustrating sub-networks, hosts, and channels and including a geographic representation of channels associated with specific geographic locations from different perspectives.

A database of IP addresses correlated to latitude and longitude coordinates may be loaded into memory of computing systems practicing embodiments of the present disclosure. Newly discovered hosts may be checked against the database for a valid location. Hosts that are discovered may be placed on a geographical representation of the Earth with latitude and longitude coordinates translated to X and Y coordinates. Hosts that are not found in the database may be placed in an unassigned sub-network or grouping in front of the map (e.g., depicted as floating above the Earth in 3D space). Region 2410 illustrates some unassigned sub-networks and hosts. Curved line 2420 illustrates a channel between an unassigned host and a host identified as located near Japan. Curved line 2430 illustrates a channel between a host identified as located near Japan and a host identified as located near Idaho. Channels that have at least one of the hosts identified to a geographical location may be referred to herein as part of “geo-located conversations.”

In FIG. 24C, a relatively close-up illustration shows a pyramid structure 2440 representing an unidentified sub-network and curved line 2450 representing a channel between a host identified as located near Japan and a host in the unidentified sub-network.

Displaying information in three dimensions that then gets compressed down to two dimensions when viewed on a monitor can potentially lead to confusing displays. In order to alleviate this confusion a sophisticated navigation system is required. Smoothly changing the camera perspective in the 3D environment allows for the human brain to reconstruct the 3D environment despite seeing only a series of 2D projections of the environment. Embodiments of the present disclosure include user navigation tools for navigating a 3D environment as it applies to a 3D network rendering.

Modern game controllers have 2 or more 2-axis analog controllers. These controls allow the user to control the translational camera perspective using one 2-axis input and the rotational camera perspective using another 2-axis input. This gives the user much better control over the camera perspective than is normally available using a mouse and keyboard.

The mouse and keyboard may still be used, such as, for example, the keyboard for translational camera perspective changes and the mouse for rotational perspective changes.

IP addresses in the 2D environment may be followed by a camera icon. By clicking on this icon, the 3D camera perspective moves smoothly from its current location to the one focused on the host.

In some embodiments, the user can open a dialog box and type any IP address. The camera will then smoothly move to focus on that host if it exists in the fingerprint. If it does not exist in the fingerprint, then the dialog box changes color to indicate that the search failed.

Some embodiments allow the user to save camera perspectives that the user finds useful and informative about their network. Once saved, the user can smoothly transition the camera back to the position from anywhere using a keyboard shortcut.

Some embodiments make the user an integral part of the fingerprinting process. The user is the one with situational awareness and Sophia is designed to improve the user's situational awareness. This is different from most network security appliances that try to reduce the amount of human time necessary for its operation.

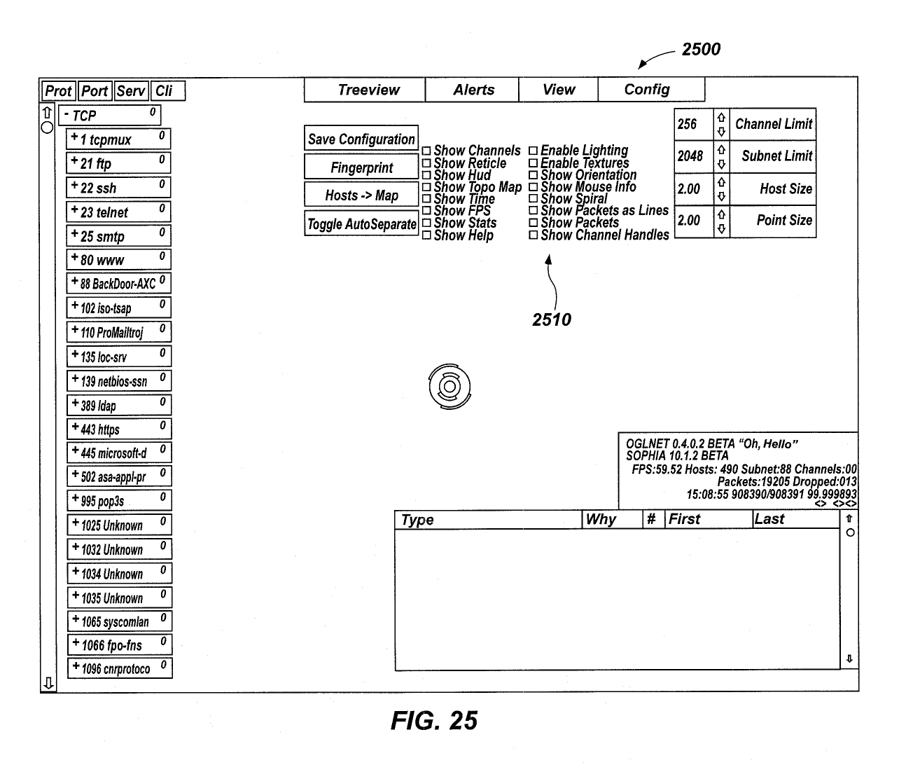

The 3D rendering of the Sophia fingerprint is very useful for visual learning about a network, but it may not always allow a user to find and organize data in a manner that is conducive to learning about the specific pieces of the network. A heads-up display (HUD) may be configured to organize the network fingerprint information using different methods (the channel tree and alerts display) that allow the user to find the information they need when tracking down specifics. The HUD may be seen in the upper right regions of FIGS. 19 and 22 and another non-limiting example of a HUD configuration is illustrated at region 2510 of a GUI 2500 in FIG. 25. Some embodiments may enable the user to rename IP addresses and services, which allows users to create aliases for their systems and improve the speed at which decisions can be made.

While the invention is susceptible to various modifications and implementation in alternative forms, specific embodiments have been shown by way of non-limiting example in the drawings and have been described in detail herein. It should be understood that the invention is not intended to be limited to the particular forms disclosed. Rather, the invention includes all modifications, equivalents, and alternatives falling within the scope of the following appended claims and their legal equivalents.

1. A method for monitoring a network, comprising:
capturing communication data from the network in a substantially passive manner;
organizing the communication data to represent a plurality of conversations between a plurality of hosts on the network, each conversation of the plurality including a first address of a first host of the plurality of hosts, a service port identifier on the first host, and a second address of a second host of the plurality of hosts; and
presenting information correlated to at least some of the plurality of conversations on a graphical user interface.

2. The method of claim 1, further comprising determining each of the plurality of conversations by creating a host record including an Internet protocol address of the first host as the first address, a service record including the host record and the service port identifier, a channel record including the service record and an Internet protocol address of the second host as the second address.

3. The method of claim 2, further comprising creating a session record including the channel record and a client port identifier on the second host.

4. The method of claim 1, further comprising creating a baseline fingerprint by classifying a list of the plurality of conversations into an acceptable traffic category and an unacceptable traffic category.

5. The method of claim 4, further comprising:
detecting an anomalous conversation comprising a new conversation or an abnormal conversation;
classifying the anomalous conversation into an undetermined traffic category; and
presenting the undetermined traffic category on the graphical user interface.

6. The method of claim 5, further comprising enabling a user to select the anomalous conversation and assign the anomalous conversation to one of the acceptable traffic category, the unacceptable traffic category, and the undetermined traffic category.

7. The method of claim 1, further comprising:
presenting the plurality of conversations on the graphical user interface in a permutable tree structure comprising related elements including:
a server address comprising at least one of the first address and the second address;
a client address comprising at least one of the first address and the second address;
a protocol identified for at least one conversation of the plurality of conversations between the server address and the client address; and
the service port identifier;
enabling a user to modify the permutable tree structure to organize the related elements in a desired order; and
re-presenting the permutable tree structure in the desired order.

8. The method of claim 1, further comprising:
receiving a packet from the network between a source host with a source port identifier and a destination host with a destination port identifier;
assigning the source host as a client if the packet is a User Datagram Protocol (UDP) broadcast packet;
determining a possible client as:
the destination host if the source port identifier is lower than or equal to the destination port identifier; or
the source host if the source port identifier is larger than the destination port identifier;
assigning the possible client as the client if:
the packet is a UDP packet, but not a broadcast packet; or
the packet is not a UDP packet and does not include handshake information; and
decoding the packet if the packet is not a UDP packet and includes handshake information to determine the client.

9. The method of claim 1, further comprising presenting a three-dimensional environment as part of the graphical user interface, the three-dimensional environment including a graphical representation of at least some of the plurality of hosts, and at least some of the plurality of conversations between the plurality of hosts.

10. The method of claim 9, further comprising:
presenting the plurality of conversations on the graphical user interface in a permutable tree structure comprising related elements; and
presenting graphical representations correlated to one or more of the related elements of the permutable tree structure in the three-dimensional environment.

11. The method of claim 9, further comprising presenting in the three-dimensional environment a graphical representation of one or more sub-networks including at least some of the plurality of hosts that are identified as residing in a same sub-network.

12. The method of claim 11, further comprising enabling a user to move the graphical representations of the one or more sub-networks, the plurality of hosts, and the plurality of conversations to a different location within the three-dimensional environment with a drag-and-drop operation.

13. The method of claim 11, further comprising moving the graphical representation of at least one sub-network of the one or more sub-networks by a predetermined amount in a direction substantially perpendicular to a baseline plane each time traffic is detected that is related to the at least one sub-network.

14. The method of claim 9, further comprising providing user navigation tools enabling a user to adjust a view of the three-dimensional environment by performing at least one operation selected from the group consisting of rotating about an axis, translation, zoom in, zoom out, and fly over a selected region.

15. The method of claim 9, further comprising presenting in the three-dimensional environment a geographical representation of at least a portion of the Earth, wherein at least one of the plurality of conversations is presented as a geo-located conversation connected with a specific location on the geographical representation that is correlated with at least one host of the plurality of hosts associated with the geo-located conversation.

16. A network monitoring system, comprising:
at least one collector coupled with a network, and configured to capture communication data from the network in a substantially passive manner;
at least one aggregator configured to:
receive the communication data from the at least one collector; and
organize the communication data to represent a plurality of conversations between a plurality of hosts on the network, each conversation of the plurality including a first address of a first host of the plurality of hosts, a service port identifier on the first host, and a second address of a second host of the plurality of hosts; and
a graphical user interface configured to present information correlated to at least some of the plurality of conversations.

17. The network monitoring system of claim 16, wherein the at least one aggregator is further configured to determine each of the plurality of conversations by creating a host record including an Internet protocol address of the first host as the first address, a service record including the host record and the service port identifier, a channel record including the service record and an Internet protocol address of the second host as the second address.

18. The network monitoring system of claim 17, wherein the at least one aggregator is further configured to create a session record including the channel record and a client port identifier on the second host.

19. The network monitoring system of claim 16, wherein the at least one aggregator is further configured to create a baseline fingerprint by classifying a list of the plurality of conversations into an acceptable traffic category and an unacceptable traffic category.

20. The network monitoring system of claim 19, wherein the at least one aggregator is further configured to:
detect an anomalous conversation comprising a new conversation or an abnormal conversation;
classify the anomalous conversation into an undetermined traffic category; and
present the undetermined traffic category on the graphical user interface.

21. The network monitoring system of claim 20, wherein the at least one aggregator is further configured to enable a user to select the anomalous conversation and assign the anomalous conversation to one of the acceptable traffic category, the unacceptable traffic category or the undetermined traffic category.

22. The network monitoring system of claim 16, wherein the at least one aggregator is further configured to:
present the plurality of conversations on the graphical user interface in a permutable tree structure comprising related elements including:
a server address comprising at least one of the first address and the second address;
a client address comprising at least one of the first address and the second address;
a protocol identified for at least one conversation of the plurality between the server address and the client address; and
the service port identifier;
enable a user to modify the permutable tree structure to organize the related elements in a desired order; and
re-present the permutable tree structure in the desired order.

23. The network monitoring system of claim 16, wherein the at least one aggregator is further configured to:
receive a packet from the network between a source host with a source port identifier and a destination host with a destination port identifier;
assign the source host as a client if the packet is a User Datagram Protocol (UDP) broadcast packet;
determine a possible client as:
the destination host if the source port identifier is lower than or equal to the destination port identifier; or
the source host if the source port identifier is larger than the destination port identifier;
assign the possible client as the client if:
the packet is a UDP packet, but not a broadcast packet; or
the packet is not a UDP packet and does not include handshake information; and
decode the packet if the packet is not a UDP packet and includes handshake information to determine the client.

24. The network monitoring system of claim 16, wherein the at least one aggregator is further configured to present a three-dimensional environment as part of the graphical user interface, the three-dimensional environment including a graphical representation of at least some of the plurality of hosts, and at least some of the plurality of conversations between the plurality of hosts.

25. The network monitoring system of claim 24, wherein the at least one aggregator is further configured to:
present the plurality of conversations on the graphical user interface in a permutable tree structure comprising related elements; and
present graphical representations correlated to one or more of the related elements of the permutable tree structure in the three-dimensional environment.

26. The network monitoring system of claim 24, wherein the at least one aggregator is further configured to present in the three-dimensional environment a graphical representation of one or more sub-networks including at least some of the plurality of hosts that are identified as residing in a same sub-network.

27. The network monitoring system of claim 26, wherein the at least one aggregator is further configured to enable a user to move the graphical representations of the one or more sub-networks, the plurality of hosts, and the plurality of conversations to a different location within the three-dimensional environment with a drag-and-drop operation.

28. The network monitoring system of claim 26, wherein the at least one aggregator is further configured to move the graphical representation of at least one sub-network of the one or more sub-networks by a predetermined amount in a direction substantially perpendicular to a baseline plane each time traffic is detected related to the at least one sub-network.

29. The network monitoring system of claim 24, wherein the at least one aggregator is further configured to provide user navigation tools enabling a user to adjust a view of the three-dimensional environment by performing at least one operation selected from the group consisting of rotating about an axis, translation, zoom in, zoom out, and fly over a selected region.

30. The network monitoring system of claim 24, wherein the at least one aggregator is further configured to present in the three-dimensional environment a geographical representation of at least a portion of the Earth, wherein at least one of the plurality of conversations is presented as a geo-located conversation connected with a specific location on the geographical representation that is correlated with at least one host of the plurality of hosts associated with the geo-located conversation.

31. Computer-readable storage media including computing instructions, which when executed by a computing device cause the computing device to:
capture communication data from a network in a substantially passive manner;
organize the communication data to represent a plurality of conversations between a plurality of hosts on the network, each conversation of the plurality including a first address of a first host of the plurality of hosts, a service port identifier on the first host, and a second address of a second host of the plurality of hosts; and
present information correlated to at least some of the plurality of conversations on a graphical user interface.

32. The computer-readable storage media of claim 31, wherein the computing instructions further cause the computing device to create a baseline fingerprint by classifying a list of the plurality of conversations into an acceptable traffic category and an unacceptable traffic category.

33. The computer-readable storage media of claim 32, wherein the computing instructions further cause the computing device to:
detect an anomalous conversation comprising at least one of a new conversation and an abnormal conversation;
classifying the anomalous conversation into an undetermined traffic category;
present the undetermined traffic category on the graphical user interface; and
enable a user to select the anomalous conversation and assign it to one of the acceptable traffic category, the unacceptable traffic category and the undetermined traffic category.

34. The computer-readable storage media of claim 31, wherein the computing instructions further cause the computing device to:
present the plurality of conversations on the graphical user interface in a permutable tree structure comprising related elements including:
a server address comprising at least one of the first address and the second address;
a client address comprising at least one of the first address and the second address;
a protocol identified for at least one conversation of the plurality between the server address and the client address; and
the service port identifier;
enable a user to modify the permutable tree structure to organize the related elements in a desired order;
re-present the permutable tree structure in the desired order;
enable the user to select from at least one conversation among the plurality of conversations; and
present information related to the selected at least one conversation in a three-dimensional environment of the graphical user interface.

35. The computer-readable storage media of claim 31, wherein the computing instructions further cause the computing device to:
receive a packet from the network between a source host with a source port identifier and a destination host with a destination port identifier;
assign the source host as a client if the packet is a User Datagram Protocol (UDP) broadcast packet;
determine a possible client as:
the destination host if the source port identifier is not larger than the destination port identifier; or
the source host if the source port identifier is larger than the destination port identifier;
assign the possible client as the client if:
the packet is a UDP packet, but not a broadcast packet; or
the packet is not a UDP packet and does not include handshake information; and
decode the packet if the packet is not a UDP packet and includes handshake information to determine the client.

36. The computer-readable storage media of claim 31, wherein the computing instructions further cause the computing device to present a three-dimensional environment as part of the graphical user interface, the three-dimensional environment including a graphical representation of at least some of the plurality of hosts, and at least some of the plurality of conversations between the plurality of hosts.
